(19) United States
(12) Patent Application Publication
(10) Pub. No.: US 2016/0357872 A1
(43) Pub. Date: Dec. 8, 2016

(54) EVENT NETWORKS AND EVENT VIEW CONSTRUCTION AND DISPLAY

(71) Applicants: Anthony Fader, Seattle, WA (US); Thiyagaraja Pattabhiraman, Redmond, WA (US); William G. Bronske, Snohomish, WA (US); Ryan Scott Lewis, Seattle, WA (US); Joshua Guralnick Karp, Seattle, WA (US); Aaron Grey Johnson, Seattle, WA (US); David Neil MacDonald, Seattle, WA (US); Kenneth Edward McGrady, JR., Seattle, WA (US); Ashley McKnight Miller, Seattle, WA (US); Cooper Crosby, Seattle, WA (US); Ryan Jeffrey Hoback, Seattle, WA (US)

(72) Inventors: Anthony Fader, Seattle, WA (US); Thiyagaraja Pattabhiraman, Redmond, WA (US); William G. Bronske, Snohomish, WA (US); Ryan Scott Lewis, Seattle, WA (US); Joshua Guralnick Karp, Seattle, WA (US); Aaron Grey Johnson, Seattle, WA (US); David Neil MacDonald, Seattle, WA (US); Kenneth Edward McGrady, JR., Seattle, WA (US); Ashley McKnight Miller, Seattle, WA (US); Cooper Crosby, Seattle, WA (US); Ryan Jeffrey Hoback, Seattle, WA (US)

(21) Appl. No.: 15/173,548

(22) Filed: Jun. 3, 2016

Related U.S. Application Data
(60) Provisional application No. 62/171,914, filed on Jun. 5, 2015.

(51) Int. Cl. G06F 17/30

(52) U.S. Cl. CPC G06F 17/30867; G06F 17/30528; G06F 17/3053; G06F 17/30554; G06F 17/30958; G06F 17/30377; G06F 17/30525

(57) ABSTRACT

An event network system can provide user-friendly grouping of articles, or “events views,” which can comprises multiple automatically obtained digital content items related to a specified event. The event network system can accomplish this by discovering digital content, analyzing it, searching for and retrieving additional related digital content, producing an similarity graph indicating the relatedness of identified digital content, and producing event views for sufficiently related digital content items. The event views can encapsulate, summarize, tag, and link the related digital content items in a manner that allows for easy user consumption. The event network system can also determine events to include in a thread of recommended events, e.g. based on an interest score for a user. A user can also search an event network, which can provide suggested results based on a freshness score.

### CROSS-REFERENCE TO RELATED APPLICATIONS

This application is a non-provisional of and claims priority to U.S. Provisional Patent Application No. 62/171,914, entitled “Event-Centered System and Method for Selecting, Presenting and Updating Content and Sentiment Surrounding the Event,” filed on Jun. 5, 2014, which is hereby incorporated by reference in its entirety for all purposes.

### BACKGROUND

The number of Internet users has increased dramatically since the mid-1990s to well over two billion users. Internet users spend increasingly more time on the Internet, sometimes spending more time socializing online than socializing face-to-face. Content, including articles, publications, videos, and commentary, is constantly being created and added to the Internet, making the Internet a filing cabinet of information, events, reactions, and emotions. Today, Internet users can access content by specifying search parameters in a search engine and receiving in response a listing of links to various websites that may relate to the search parameters. Typically, the results are displayed in a scrollable list of links that can include a snippet of the content that is found if a user clicks on the link.

### BRIEF DESCRIPTION OF THE DRAWINGS

FIG. 1 is a block diagram illustrating an overview of devices on which some implementations can operate.

FIG. 2 is a block diagram illustrating an overview of an environment in which some implementations can operate.

FIG. 3 is a block diagram illustrating a process used in some implementations for interactions between a client and a server implementing an event network system.

FIG. 4 is a table illustrating signals of user characteristics, metrics for gathering values for the user characteristics, how the characteristics are interpreted for user intent, and weighting factors for the user characteristics.

FIG. 5A-FIG. 5C is an example illustrating generation of search results on an event network.

FIG. 6 is an example illustrating predictive search results and thread selection.

FIG. 7 is an example illustrating a similarity graph.

FIG. 8 is an example of a quote associated with a particular source.

FIG. 9 is a flow diagram illustrating a content pipeline process used in some implementations for obtaining and inserting content items into an event network.

FIG. 10 is an example illustrating a cast of characters associated with an event.

FIG. 11 is an example illustrating a source article clip.

FIG. 12 is an example of a threadboard displayed on a graphical user interface in some implementations.

FIG. 13 is an example of event cards displayed on a graphical user interface in some implementations.

FIG. 14 is an example of a single event card with an event hook displayed on a graphical user interface in some implementations.

FIG. 15 is an example of an event detail view displayed on a graphical user interface in some implementations.

FIG. 16 is an example of an event network view displayed on a graphical user interface in some implementations.

FIG. 17 is an example illustrating a cast of characters associated with an event.

FIG. 18 is an example of a quote associated with a particular source.

FIG. 19 is a flowchart illustrating how a threadboard can be created.

FIGS. 20-25 are flowcharts with examples of user interactions with the threadboard.

FIGS. 26-28 are examples illustrating generation of search results on an event network.

FIG. 29 is a flowchart showing an example of constructing a threadboard.

### DETAILED DESCRIPTION

An event network system can provide user-friendly groupings of articles or “event views,” which can comprise multiple automatically obtained digital content items related to specified events. The event views can be a machine-constructed view of one or more events in an event network that are within a threshold relationship distance to a subject. The event views can be arranged as event cards in linear threads in a threadboard. The threadboard is a customizable display of threads, where each thread has a subject (e.g., topic entity, or emotion), and each thread includes a series of event cards related within a threshold relationship distance to the subject of the thread.

Massive amounts of interrelated digital content is produced every day. Consumers of this digital content may only get part of the story relating to an event because they are unaware of other sources of data or because they don't have the time or inclination to sift through the multiple varied content sources to locate and read related content. The event network system described herein provides a fuller, more user-friendly, picture of events by providing event views, which can comprises multiple automatically obtained digital content items related to a specified event. The event network system can accomplish this by discovering digital content, analyzing it, searching for and retrieving additional related digital content, producing an similarity graph indicating the relatedness of identified digital content, and producing event views for sufficiently related digital content items. The event views can encapsulate, summarize, tag, and link the related digital content items in a manner that allows for easy user consumption.

As used herein, an “event network” is a network of objects each corresponding to a happening or series of related happenings in the world with defined relationships between the objects in the network. Objects can include, but are not limited to, news articles, blogs, social network postings, images, videos, quotes from people, tags, or comments on other objects in the event network. A system for constructing, modifying, and maintaining an event network is referred to herein as a “content pipeline.” A content pipeline can modify an event network as new objects are added or removed from the event network, as existing objects are modified, or as relationships between objects are added, removed, or differently weighted. For example, event networks can evolve as users, curators, and other entities modify and interact with objects in the event network. Interactions can include, but are not limited to: tagging, commenting, adding material, re-arranging, voting on changes, editing, or polling.

As used herein, an “event view” can be a machine-constructed view of one or more events in an event network that are within a threshold relationship distance to a subject object in the event network. Event views can be re-constructed or modified as new objects are added or removed from the event network, as existing objects are modified, or as relationships between objects are added, removed, or differently weighted. Event views are described in more detail in a PCT Patent Application PCT/US2016/035909 entitled EVENT NETWORKS AND EVENT VIEW CONSTRUCTION AND DISPLAY, with attorney docket number 119998-8002.WO00, filed concurrently herewith, and incorporated herein by reference.

### System Overview

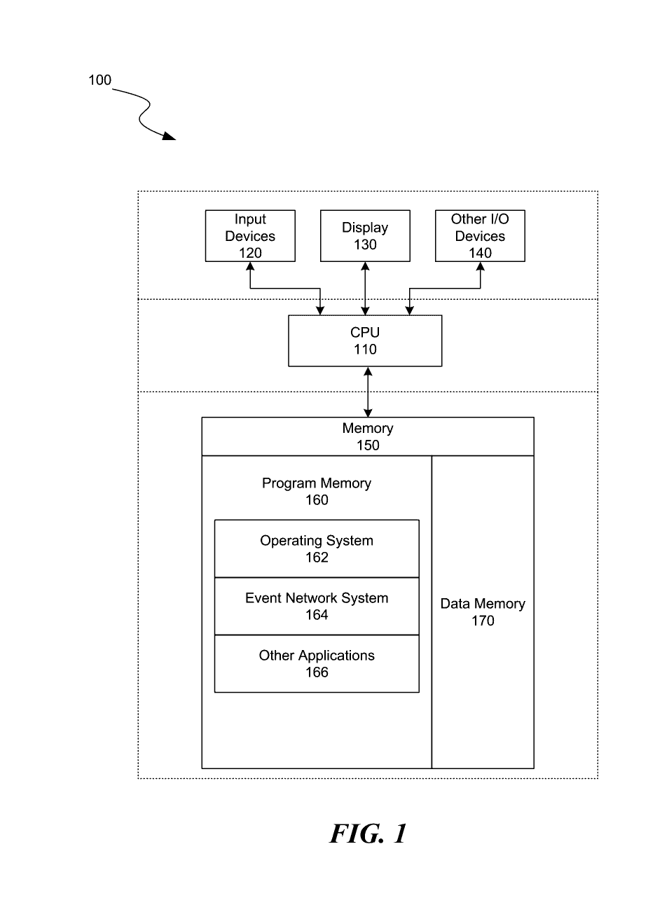

Several implementations are discussed below in more detail in reference to the figures. Turning now to the figures, FIG. 1 is a block diagram illustrating an overview of devices on which some implementations of the disclosed technology can operate. The devices can comprise hardware components of a device 100 that can build and use an event network. Device 100 can include one or more input devices 120 that provide input to the CPU (processor) 110, notifying it of actions. The actions can be mediated by a hardware controller that interprets the signals received from the input device and communicates the information to the CPU 110 using a communication protocol. Input devices 120 include, for example, a mouse, a keyboard, a touchscreen, an infrared sensor, a touchpad, a wearable input device, a camera- or image-based input device, a microphone, or other user input devices.

CPU 110 can be a single processing unit or multiple processing units in a device or distributed across multiple devices. CPU 110 can be coupled to other hardware devices, for example, with the use of a bus, such as a PCI bus or SCSI bus. The CPU 110 can communicate with a hardware controller for devices, such as for a display 130. Display 130 can be used to display text and graphics. In some examples, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The CPU 110 can have access to a memory 150. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 150 can include program memory 160 that stores programs and software, such as an operating system 162, event network system 164, and other application programs 166. Memory 150 can also include data memory 170 that can include configuration data, settings, user options or preferences, etc., which can be provided to the program memory 160 or any element of the device 100.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

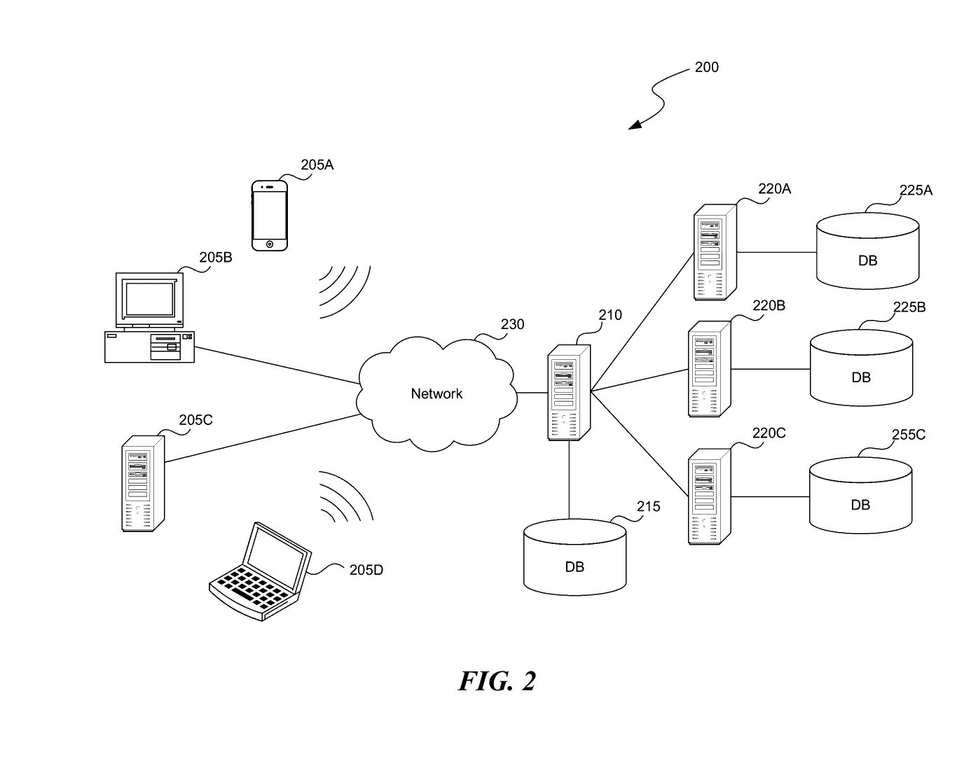

FIG. 2 is a block diagram illustrating an overview of an environment 200 in which some implementations of the disclosed technology can operate. Environment 200 can include one or more client computing devices 205A-D, examples of which can include device 100. Client computing devices 205 can operate in a networked environment using logical connections 210 through network 230 to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g. store) information. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

Those skilled in the art will appreciate that the components illustrated in FIGS. 1 and 2 described above, and in each of the diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

System Details

A content pipeline can be a series of relatively independent services, arranged into a sequence. The content pipeline can be responsible for discovering and gathering source material, analyzing it, searching for and retrieving additional related data, and producing and storing an event network. A content pipeline can be modified over time as new forms of objects and new event view requirements are determined. Some of the content pipeline services, or portions thereof, can be performed on a local system, while others of these services or portions thereof can be performed using external systems.

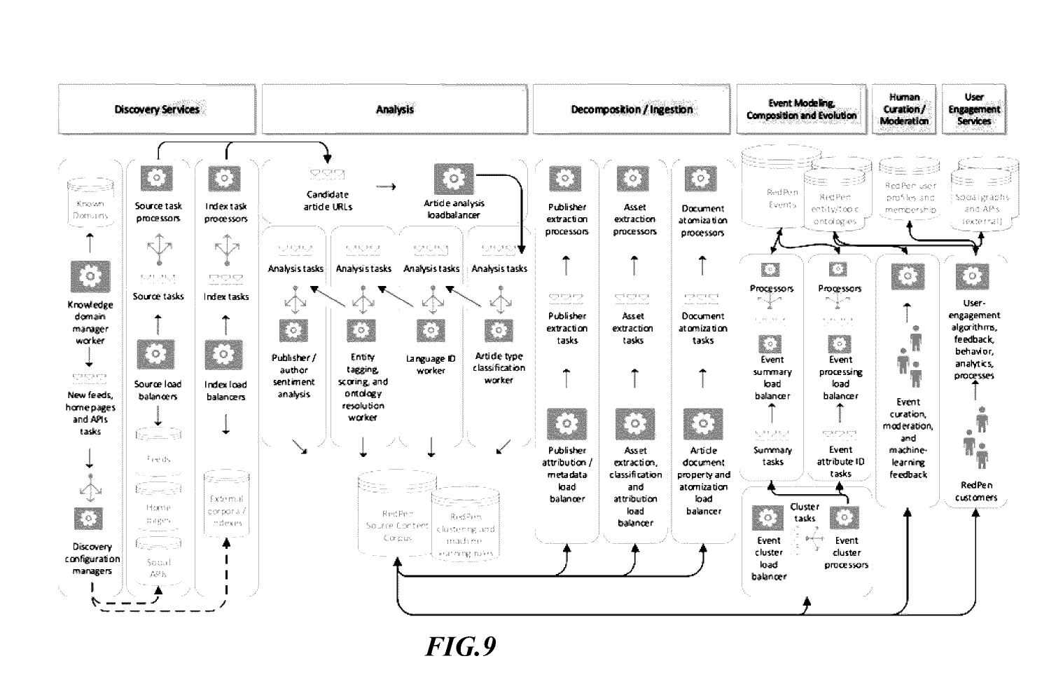

In some implementations, a general processing flow, in approximate temporal order, which can be used by the event network service can be: discovery, ingestion, decomposition, article analysis, clustering, consulting additional assets, producing event summaries, and extracting and storing associated clips. Each of these processing stages is described in greater detail below. In various implementations, the sequence of stages in the processing flow can be rearranged, processes can be omitted, or other processes can be added. For example, another temporal order for the processing stages and data flow, which is shown in FIG. 9, includes: discovery; content analysis; decomposition/ingestion; event modeling, composition, and evolution; human curation/moderation; and user engagement services.

### Discovery Services

Many diverse data sources can be monitored for content to include in an event network. For example, sources can include new articles; web pages; announcements; subscribed agency feeds (e.g. the Associated Press); RSS feeds from newspapers, magazines, etc.; home pages for newspapers, magazines, etc.; blogs or other publications; social media sources; etc. Items identified from such sources are collectively referred to herein as “articles.”

The modules and processes in this section can relate to discovery and selection of content domains from the internet that serve as “raw material” for crafting of event networks. A knowledge domain manager module can filter in-flowing content in known domains of subject matter. Discovery configuration managers can monitor news feeds, home pages, and other APIs, and select content for storage and analysis.

The discovery services tasks can be grouped into source and index tasks. Task-based computing can process items such as feeds, homepages, social APIs, and other external data. Appropriate load balancers can mediate these processes.

Analysis

The modules and processes in this stage can be given candidate article URLs as input and specialize in performing various types of analysis, such as: identifying the language of the article (and retaining articles in English); assigning type labels to articles; analyzing publisher/author sentiment (e.g. based on sentiment indicators in the content item indicators in a sentiment lexicon); and resolving entities (persons, places, organizations and other entities mentioned in articles) against ontologies (graph structures in which entities are organized).

The performance of these tasks can be regulated by an article analysis load balancer. Content so analyzed can be installed in the source content database (referred to herein as a “corpus”). The corpus, along with clustering/machine learning rules, constitute input data and knowledge, driving the next stage—decomposition.

Each article and its components can be analyzed, and results can be stored and associated with that article. Some of the steps carried out during this stage of analysis can be: named entity identification, quote attribution, and image processing.

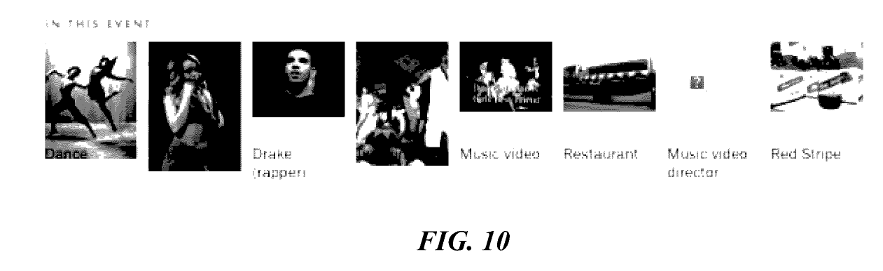

Named Entity Identification: Named Entities and topics can be detected and mapped to information about them. The principal named entities (people, places, organizations, etc.) mentioned in the article can be detected by a named entity identifier. For example, a Diffbot service can be used to detect and deliver identifications of named entities to the content pipeline. Diffbot is further described in https://www.diffbot.com/, incorporated herein by reference. These named entities can be identified in a “tags” field for the article, e.g. “tags”: [{“score”: 0.57, “count”: 1, “label”: “List of Presidents of Burundi”, “uri”: “http://dbpedia.org/resource/List_of_Presidents_of_Burundi”}]. The tags field can include such attributes of the entity as name, type, and count of occurrences in the article. Each of the resulting entities and topics can be queried in a database (e.g. DBPedia), and thumbnail images can be retrieved, linked to the article, and stored. Additional information, such as the entity description, can also be stored. The elements can be displayed in their order of importance (e.g. the most to the least important). Importance can be computed as a ranking function which takes into account both frequency and locations of occurrence in the articles in a cluster. The event network service can associate a cast of characters with a given event. The event network service can display a representation of a cast of characters, which when displayed, can show the events they are involved in, and provide users the ability to drill down and explore data and timelines associated with each character. An example representation of a cast of characters is provided in FIG. 10.

Quote Attribution: Quotes within articles can be extracted, analyzed and attributed to named entities where possible. The quotes can be located in an article through detection and matching of quotation marks. The attribution of quotes to named entities (speakers) can be accomplished by an algorithm which searches either side of the quote in two stages by: (a) looking for an expression verb such as “said”, “stated”, etc.) in a defined area around the quote, and then (b) looking for a named entity (typically, a person name) in a defined area on either side of the expression verb.

Image Processing: Images and videos can be hashed to produce globally unique identifiers (“GUIDs”), duplicates can be removed, and the images and videos can be processed to obtain a media gallery with images of consistent size and resolution characteristics. Image and video captions and metadata can be analyzed, and data obtained in this process can be used to rank images and select a primary or “hero” image, which can be displayed to the user as the “featured image” for an event view. The algorithm for ranking and hero image selection can apply a scoring criterion on sets of images (e.g. images identified by a data extraction system such as a Diffbot API) as primary images in the media galleries of the articles.

Decomposition/Ingestion

Ingestion: Once the article discovery module detects a new article, it passes the new article to an article ingestion module that can store the article in a database, with a unique article ID.

Decomposition: In some implementations, the processes in the decomposition stage can be grouped into: publisher extraction, asset extraction, and document atomization. Publisher extraction includes identifying a publisher ID and other metadata associated with article publishers. Asset extraction involves extraction of different types of assets from the articles, such as texts and media. Document atomization includes decomposing articles and identifying a portion tag for each such as headlines, sections, and paragraphs. Load balancers can regulate the performance of these process groups. Each new article can be decomposed into its component parts. The resulting decomposed component parts can be stored in a database. Examples of component part types include: publisher, author, titles or headlines, paragraphs, quotes, images and their captions, videos and their captions, charts or other infographics, and user comments. In some implementations, decomposition of an article into component parts can be accomplished through a data extraction system. The data extraction system such can receive a URL of an article and pass results can be delivered (e.g. as a JSON data structure), in which the field attributes are names of constituents, and field values are values of constituents. Next, select salient fields of the data extraction system's output that are relevant to analysis can be selected and stored in a data structure representing the article. The article data structure also contains placeholders for other types of information computed in subsequent steps.

Event Modeling, Composition, and Evolution

The event modeling, composition, and evolution stage, along with the user engagement services and human curation/moderation stages, can derive and shape event networks from articles. In some implementations, a step in the transition from articles to event networks is algorithmically grouping clusters of articles. Articles in a given cluster exist in the same event network.

Once the clusters are formed, processes in this stage (and subsequent stages) can operate on entire clusters instead of just a single article. In addition, this stage can synthesize artifacts such as headlines and summaries, which become constituents of published events. Processes in this stage can make use of entity/topic ontologies and other knowledge bases, operate on entire events (article groups/clusters) instead of just a single article, and algorithmically generate artifacts such as headlines and summaries, which form sections of events displayed to the user.

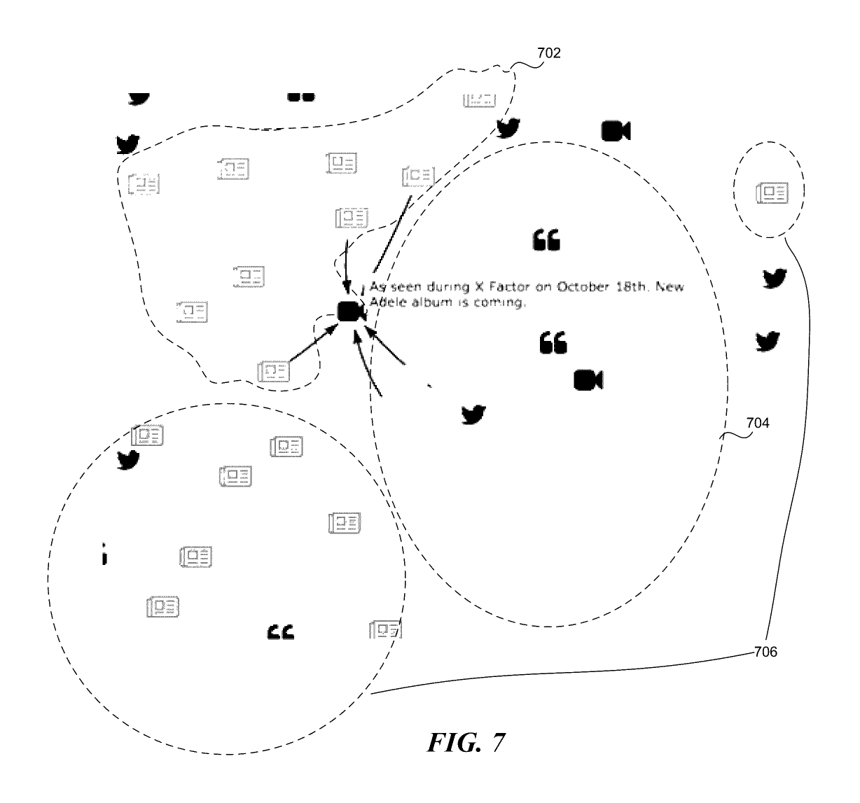

Clustering articles into event networks: A real world event or series of related events can be represented through clusters of objects which have been determined to be closely related to each other. Once articles are received, stored by creating a node, and partially analyzed, the article clustering process can be run, resulting in grouping articles into sets. Each such set can be about the same, unique, real world event or series of related events. These sets of articles are referred to as event clusters. In some implementations, event clusters can be stored in databases with unique event IDs in a JSON data structure. The number of articles in an event cluster can vary depending on the availability of articles in the article database and certain characteristics of the article clustering algorithm. The clustering algorithm can determine whether a newly-considered article should belong in an existing event/cluster, or if it defines a new event/cluster. Content item clustering provides information about the relationship of objects (events, articles, media, quotes, and social network postings) as illustrated in FIG. 7. FIG. 7 shows an event cluster where clusters are shown by like-numbered broken line enclosures and arrows show the relationship of articles, media, quotes, and twitter posts. For instance, it may be observed that articles from both the 702 cluster and the 704 cluster point to the video that is highlighted with the description displayed. The graph in FIG. 7 contains objects including published articles, videos, images, quotes from named entities, social network postings, and web pages. Items that the event network system contribute to one event can be indicated as related (e.g., color coded). In FIG. 7, the items that are in cluster 706 are considered by the event network system to contribute to one event, and those in cluster 704 contribute to another related event that is in the same graph. The event network view is built by displaying each of the objects as an icon identifying its type, and the links between it and any other object in the graph.

Article clusters can be modeled as graphs, with nodes representing articles and edges representing connections between them. The clustering algorithm can take as input an article being considered for clustering, along with the current cluster of events. The algorithm can output the updated event clusters, incorporating the current article. The steps of the clustering algorithm can include: search for articles, build a similarity graph, and find clusters using label propagation.

The searching for articles step can include searching for candidate articles similar to an input article. An query can be constructed to search for articles with similar tags to identify which articles should be connected by edges. For example, two articles with tags identified to be similar above a threshold level can be connected by an edge. The step of building a similarity graph can include generating a graph or augmenting a previously created graph based on identified similarities between the input article and candidate articles or other articles already in the graph.

Articles can be grouped into clusters based on a similarity measure computed for each pair of nodes. In some implementations, a similarity measure is computed for each possible article paring. For every pair of articles (a1, a2), some salient features can be identified, which can be used as input to compute a similarity score. In some implementations, the features used to identify similarity include one or more of: (a) presence, count, or frequency of similar quotes, (b) presence, count, or frequency of identical tags, (c) presence, count, or frequency of identical titles (headlines), or (d) a minimum number of edges that exist in the similarity graph between articles (i.e. the “distance” between nodes), or (e) any combination thereof.

The step of running the label propagation algorithm to find clusters can return a labeling for nodes in the similarity graph. Highly connected nodes are likely to have the same label. This step can label each node with the most frequently occurring label among its neighbor nodes. In some implementations, ties can be broken randomly, and/or each node can be initially given a unique label.

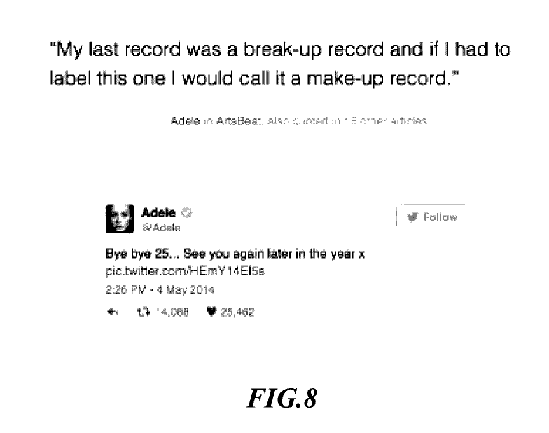

Composition: An event view can be constructed by the content pipeline to include one or more artifacts depicting information from the articles in the event. In some implementations, artifacts can include one or more of: headlines, summaries, quotes, images, audio clips, video clips, tags, topics, representations of identified entities, comments, or etc. Internal and external sources can be consulted to obtain and add more information about events, entities, and topics. Methods for this can include web crawling and searching for references to articles in the events from other articles, social media, etc. Sources can include one or more of: internal databases, external databases, social network APIs, web search engines and web crawls, or any combination thereof. An example of a quote associated with a particular source is provided in FIG. 8. Internal databases can be databases maintained in conjunction with the content pipeline. This can be accomplished by the content pipeline as it retrieves and stores content from external sources. Examples of information obtained from external sources and stored in an internal database can include information about named entities, past events and the topics they cover, articles, etc. External databases can include sources such as DBPedia and WikiData. These external sources can be consulted to obtain information about named entities and topics. External sources can also include social network APIs, such as Twitter™ feeds, Facebook™ friend graphs, and Facebook™ postings. These social network sources can be consulted to obtain postings from entities involved in events, or social network connections that any given user may have. Web search engines and web crawls can also be external sources used to discover and obtain additional data for events, such as publications, blogs, etc.

Summaries of events can be produced and/or updated and stored with an association to the corresponding event. In various implementations, summaries can be produced for articles, for entire events, or for groups of events. Summaries can be extracts from source articles or generated summaries. In some implementations, summaries can be generated using an automated summarization procedure. For example, the TextRank algorithm can be used to generate event summaries.

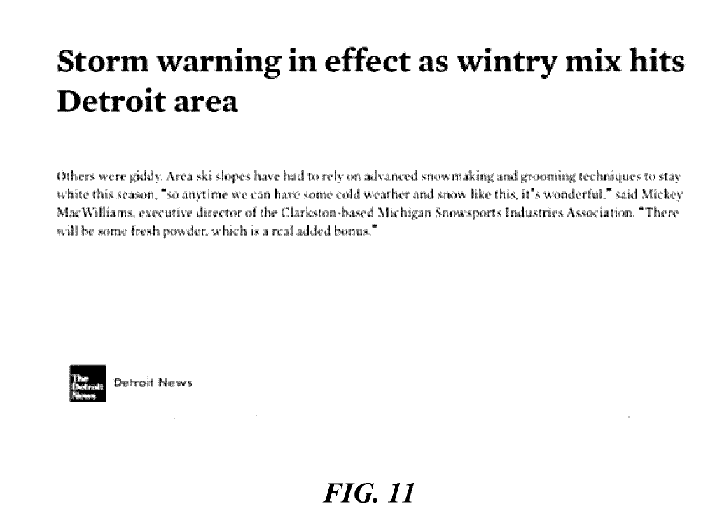

Source article clips can be extracted from each source article and stored with an association to the corresponding event. Each clip can provide a glimpse of the content of the source article and publication. An example of a source article clip is provided in FIG. 11.

Evolution: Users of event views can submit data to the event network system through their interactions, which can cause evolution of events and in associations between events in the similarity graph. Event viewers, such as members of an event view website, can tag or comment on an event view or objects within and event view. Objects which can be tagged or commented on can include one or more of: entire event views, images or sections of images, videos or sections of videos, headlines, summaries, sentences, quotes, names or identified entities, other tags, other comments, or any combination thereof. User tags can prompt creation or deletion of edges in the similarity graph, which can cause the cluster to which an article belongs to be updated to include more or less articles.

In various implementations, tags can be rich, providing multiple options, can be a single option such as “like”, or can be binary such as like/dislike. Tags can allow a user to express sentiment and/or emotion about an event or object of an event quickly and easily, in a way that can be categorized with little effort. Examples of tags can include one or more of, or a combination of: “Brilliant”, “Foolish”, “Offensive”, “False”, “True”, “Sad”, etc. In some implementations, comments can be provided by users, such as by being typed or spoken, and as the user enters a comment it can be analyzed. In some implementations where the user is appearing to express something in a comment towards one of the entities in the object they are commenting on about, the user can be prompted to verify that the service understands which entity their comment is directed at, and the user can be allowed to correct the target entity. For example, as a user types a comment beginning with “Prince,” intending to write the comment “Prince is my favorite artist,” a context menu could appear in relation to “Prince” allowing the user to select the singer/songwriter Prince Rogers Nelson; the Prince of Whales, Charles Philip Arthur George; the prince of Sweden, Carl Philip; etc. The user, seeing that the system understood him to mean the singer/songwriter Prince Rogers Nelson as intended, can continue to enter his comment. Alternatively, if the user intended to write the comment “Prince Charles was born in 1948,” he could select the second item in the context menu, such as by clicking on it or selecting it with a keyboard, signaling the intended entity to the system. Tags and comments can be stored and associated with the tagged content and the ID of the person who provided the tag or comment.

Human Curation/Moderation

In some implementations, a system curator or user can manually change features of an event network. For example, a user or curator can add, remove, or change details about an event, an event source, or connections between events in the event network. In various implementations, users or curators can perform one or more of: adding content or data directly to an event; suggesting other articles for the event network service to add to an event (e.g. using a URL); manually adding or removing articles from being associated with an event cluster; suggesting edits to textual information associated with an event; voting (up or down) on edits to text displayed in an event view; gaining or losing editing rights or capabilities based on reviews or votes of their work or actions by employees or agents; gaining or losing reputation based on reviews or votes of their work by community members, or any combination thereof.

User Engagement Services

The user engagement services stage can gather and apply various facets of knowledge about a user, such as user profile information and external information from social APIs. This state can oversee user engagement and perform analysis on user behavior. This can be accomplished using an emotion analysis on user tags and comments. The content pipeline can mine user interaction data for sentiment and emotion, acquiring data that can be summarized graphically or statistically. These statistics can be stored and available for the content pipeline to access. Tags from a user can be classified as positive, negative, or neutral. Statistical analysis can be carried out to report whether tags, on the whole, represent positive, negative, or neutral sentiment. To perform sentiment analysis on user comments, a sentiment lexicon can be used. Each word or n-gram in the sentiment lexicon has a sentiment attribute (positive, negative, neutral). Overall sentiment polarity of a user comment or group of user comments can be derived as a function of sentiment polarities of words contained therein. The results of analysis can be stored by the content pipeline, in the context of each of the objects that they apply to. These results can be available for display in event views, either for individual users or as an aggregate of user responses to the event.

Event Threadboard

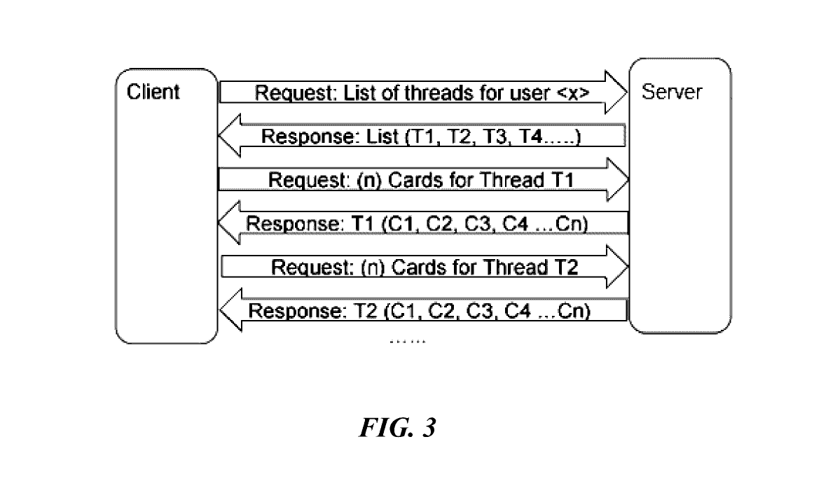

Event views created by the content pipeline described above can be organized into threads, which can be displayed on a threadboard. A thread, for example, can be a sequence of related event views. In some implementations, threads can be provided in four categories: global, recommended, emotion-based, and personal. Global threads can be threads that the event network system deems to be important or of interest to all users. For example, global threads can include top world news. These threads can be present for all users and are visible to the user regardless of whether the user is logged in. Recommended threads can be threads that are recommended to a user based on the best information (“signals”) available about the user. In some implementations, the events in the thread can be sorted left-to-right by the likelihood that the event would be of interest at that moment in time to the user. In some implementations, the recommended threads can be present and visible for users regardless of whether the user is logged in. Recommended threads are discussed in more detail below. Emotion-based threads can include events organized by the emotional aspects of their events (e.g., threads of sad or heartwarming events). In some implementations, the recommended threads can be present and visible for users regardless of whether the user is logged in. Personal: threads can include events which the user has chosen to have present in his/her personal section of the Threadboard. In some implementations, these threads are only available to users who are logged in. Methods for users to select events for their personal threads are described in more detail in the U.S. patent application entitled EVENT VIEW CONSTRUCTION AND DISPLAY, noted above. An example of client interactions with a server to operate a threadboard is shown in FIG. 3.

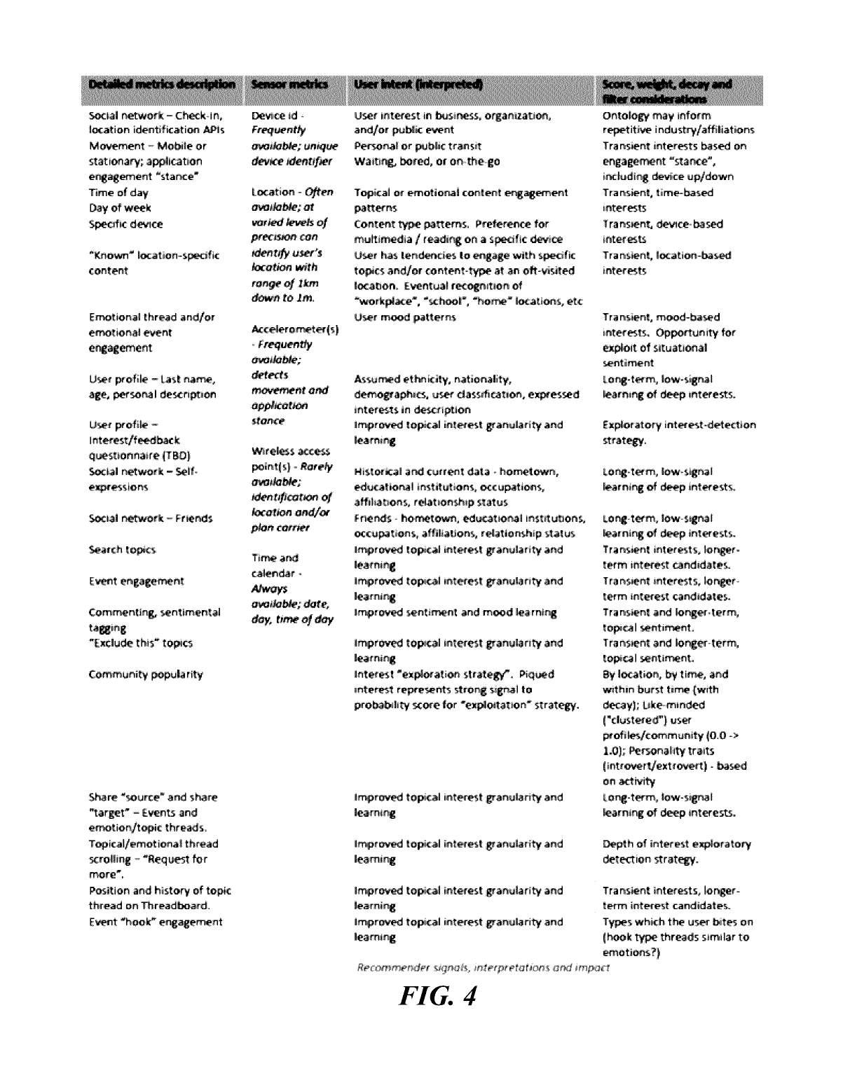

Recommended threads—When a client sends a request to the event network system, the event network system can compile a list of recommended threads, which the event network system can provide in an order sorted by relevance (e.g. the more relevant threads at the time of the request are before less relevant threads). Relevance can be calculated using the signals listed in FIG. 4, and can be adjusted based on system observations of user behavior. In some implementations, the threadboard displayed on the requesting system can display more relevant threads to the left of less relevant threads. The event network system can collect signals indicating user status, intention, interest, circumstance, or context. In some implementations, various of these signals can be collected via one or more REST endpoints. Each signal value can carry all available sensor signals from the device and/or browser client application. The availability of some sensor signals can be dictated by the user's device-specific settings. Evolution of user profiles and their related social network graphs can feed the event network system recommendation algorithms for computing expected interest scores as probabilities of user interest. The event network system can combine one or more values for available user signals, and based on the combination, select elements for a recommended thread from a set of potential elements comprising one or more of: events, topics, or entities. The selected elements can be determined to be of likely interest to the particular user for which those signal values were computed. In some implementations, based on the combination of signal values, the select events, topics, or entities can be assigned an expected interest score. In some implementations, the event network system can rank the selected events, topics, or entities, based on the corresponding expected interest score. In some implementations, the event network system can select events, topics, or entities, that have an expected interest score or rank above a threshold. The event network system can perform this ranking for selected events, topics, and entities that have an expected interest score above a threshold. Alternatively or additionally, the event network system can select events to include in the recommended thread by matching characteristics of an event against relevant features in the user's profile. This can be accomplished using a model of the user's tastes and preferences through preference elicitation.

To effectively select events for the recommended thread, information relating to the user has to be obtained, e.g. from the user dedicating an amount of effort to using the system before the system can provide any intelligent recommendations. In order to overcome this problem, the event network system can leverage information gathered about a user's location and movement for given times-of-day and days-of-the-week to compute other expected characteristics of the user based on a similarity of this information to earlier community members. This allows the event network system to accurately estimate user preference data for a particular user with no or limited amounts of data indicating the user's actual selection and interaction with digital content. These estimates can use averages or can be based on users determined to be similar to the particular user. Because the particular user can have preferences different from the average or determined similar users, early predictions of new topics can have inaccuracies. To reduce the effect of these inaccuracies, content-based filtering techniques based on item characteristics can take precedence. Data scarcity can be gap-filled using ontological relations. For example, if a user is observed to have provided a specific topic of interest signal such as “Canlis” (a fine-dining restaurant in the Seattle region) and directly-relevant events are not yet available in the system, more general topics such as “Fine Dining” or “New American cuisine” can be used as a substitute.

Event Search

As a user begins to enter a search query, the event network system can generate and display auto-complete prompts for elements corresponding to known elements comprising events, entities, or topics. In various implementations, these prompts can be ordered by freshness (current in time) or an activity level assigned to the corresponding element. The freshness or activity level can be calculated for a selected element based on a combination of one or more signals, including but not limited to: (A) a quantity score for sources of the selected element, which can be detected by the event network system on an ongoing basis, (B) recorded interactions with the selected element by other users of the event network system, interactions can include viewing, sharing, tagging, commenting, etc. or (C) activity related to the element on other social networks such as Twitter™, Facebook™, Instagram™, etc.

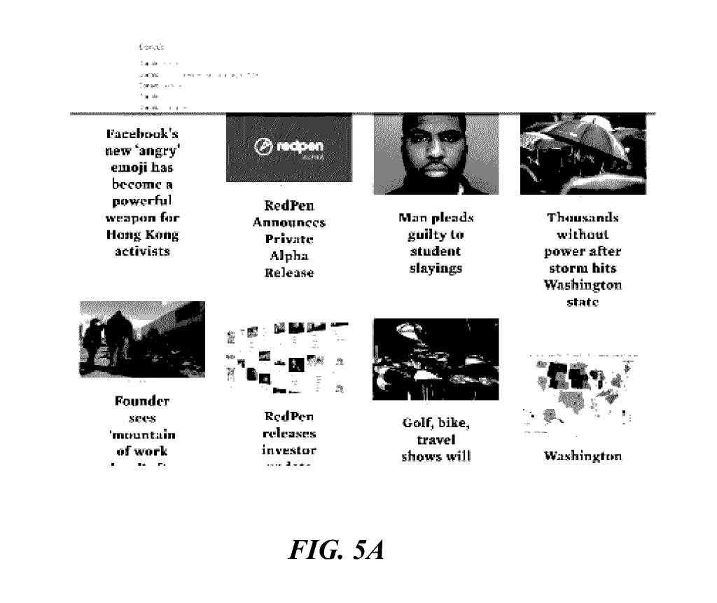

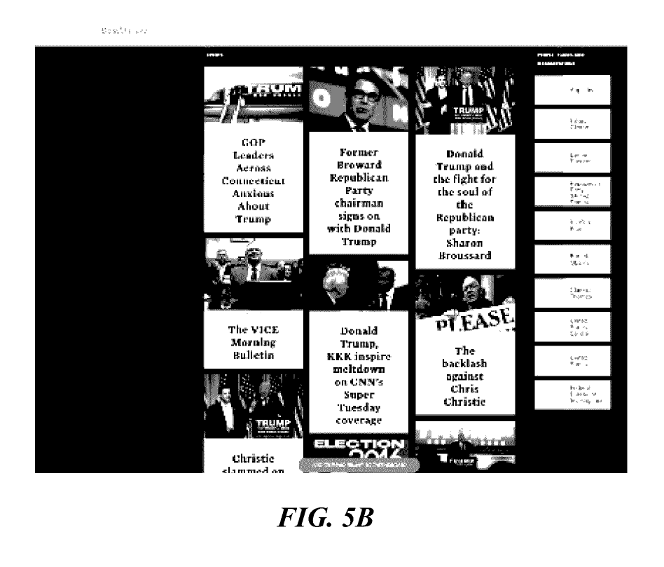

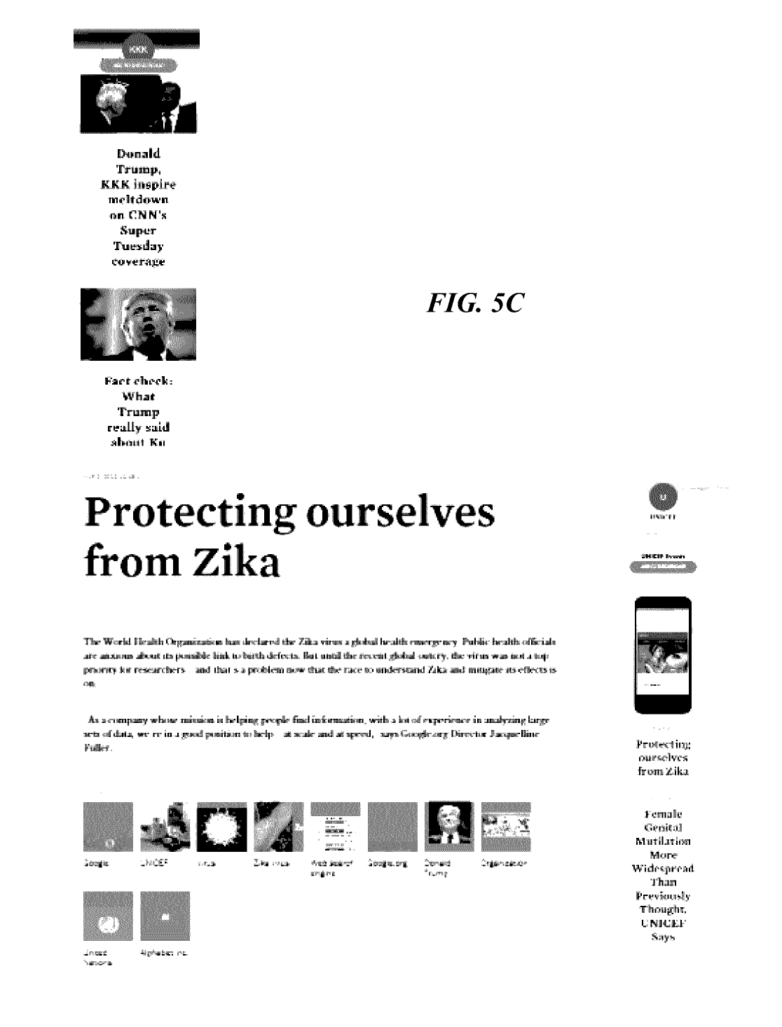

In the example shown in FIG. 5A-FIG. 5C, typing “Donald” results in an element for the entity “Donald Trump” but also an element for Donald Trump's presidential campaign, which is a more specific topic. This ability to choose very specific topics can narrow the set of returned information and can reduce clutter. This provides users significant efficiency and relevancy benefits over traditional web searches.

In the example shown in FIG. 5A-FIG. 5C, selecting “Donald Trump” can cause the event network system to search for and return a set of event cards for events in which “Donald Trump” has been identified as a named entity. Additionally, the event network system can return a set of other entities and topics that were referenced in those events, providing the user with the ability to “go down the rabbit hole” (e.g. iteratively select a related event cards of interest to the user and be presented with additional related event cards) and explore those further.

In the example shown in FIG. 5A-FIG. 5C, selecting any of the related topics can cause the system to present a thread specific to that topic, as shown. The thread can be presented with an option to add the thread to the user's Threadboard. In the example shown, the topic “Klu Klux Klan” was selected, and the system built a thread for that topic and presented it to the user. The thread can be selected to be added to the user's Threadboard.

The event network system can present a single thread view of the Threadboard, which can be chosen by the user by selecting one of the entities or topics in an event card, as shown below, where “UNICEF” was presented as a topic in the event card, and the selection resulted in a “UNICEF” thread, which can also be added to the user's Threadboard.

Constructing Search Results—A user can provide input to a search field and groups of characters can be sent to a search engine. In some implementations, the groups of characters from the user input can be collected in 100 ms intervals (e.g. a de-bounce timer interval). Each time the search engine receives a group of characters, it can respond with suggested topics. As the user continues to enter input, the topics returned can be more and more specific. The user can continue to enter input (e.g. typing, talking, swiping, pointing, etc.), or submit the search form in one of two ways: (1) by selecting one of the specific suggested topics, or (2) by typing up to any point and then activation a search function (such as by pressing enter). In embodiments where the user selects a specific suggested topic, the search can be more specific than for an arbitrary set of characters or words, which is treated as a keyword search. In either case, a collection of event cards and related topics can be returned.

Search flow—Selecting a prompt returned by the event network system can result in specific search results related to the corresponding topic identified in the event network system. In some cases, the user input can correspond to no specific topic, thus the event network system may not display any and prompts. If the user activates the search function at that point (e.g. by pressing “enter”), the event network system can perform the search as an elastic matching keyword search and results can cover a variety of topics.

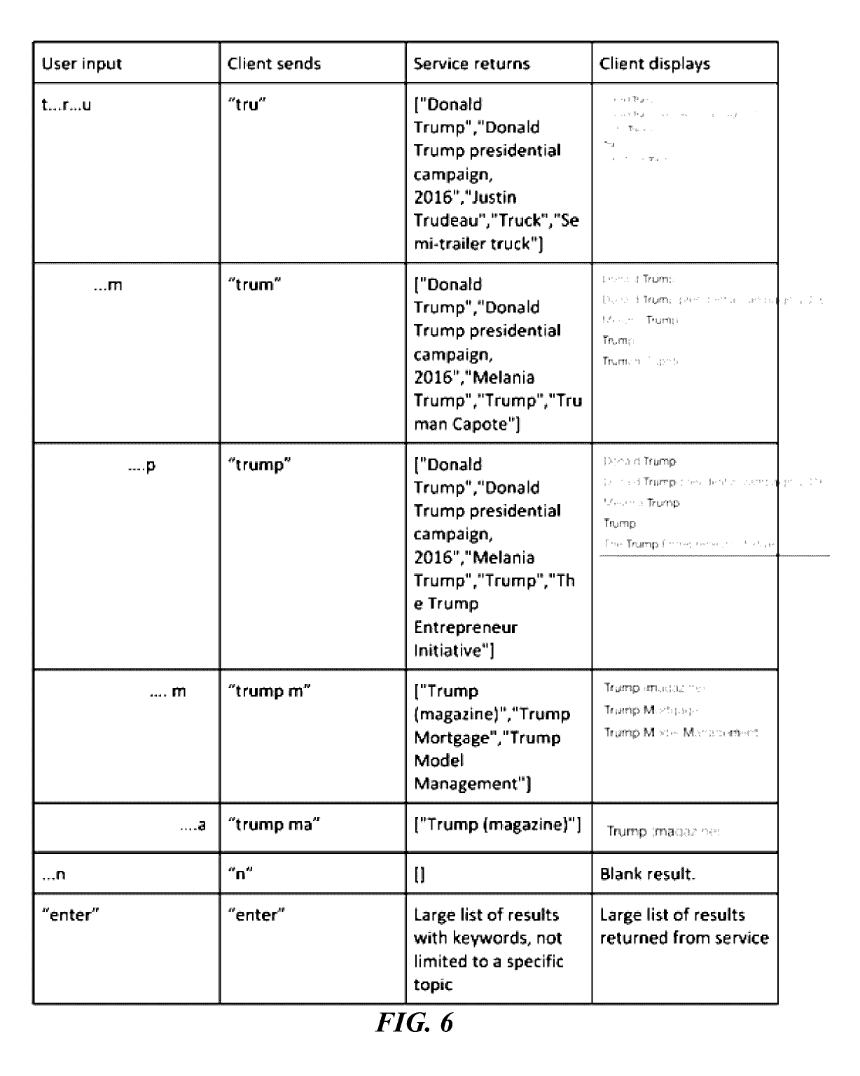

An example showing receiving groups of user input characters, the event network system providing results, and those results being provided for display on a client is provided in FIG. 6.

### Event View Construction and Display

A massive amount of interrelated digital content is produced every day. Consumers of this digital content may get only part of the story relating to an event because they are unaware of other sources of data or because they lack the time or inclination to sift through the multiple varied content sources to locate and read related content. The event views described herein provide a fuller, more user-friendly picture of events. The event views are created by an event network system and comprise multiple automatically obtained digital content items related to a specified event. The event network system can create the event views by discovering digital content, analyzing it, searching for and retrieving additional related digital content, producing a similarity graph indicating the relatedness of identified digital content, and producing event views for sufficiently related digital content items. The event views can encapsulate, summarize, tag, and link the related digital content items in a manner that allows for easy user consumption.

As used herein, an “event view” can be a machine-constructed view of one or more events in an event network that are within a threshold relationship distance to a subject object in the event network. Event views can be reconstructed or modified as new objects are added or removed from the event network, as existing objects are modified, or as relationships between objects are added, removed, or differently weighted. The event views can be presented in various ways. In some embodiments, event views are arranged as event cards in threads, which can be displayed on a threadboard. The threadboard is a customizable display of threads, each thread having a subject (e.g., topic entity or emotion) and each thread including a series of event cards related within a threshold relationship distance to the subject of the thread. The user can change (e.g., narrow, broaden) the subject of the thread, thereby creating a different display of event views within the threads. The threads can be moved, deleted, added, merged, and changed dynamically, changing the event cards in the thread.

As used below, an “event network” is a network of objects each corresponding to a happening or series of related happenings in the world with defined relationships between the objects in the network. Objects can include, but are not limited to, news articles, blogs, social network postings, images, videos, quotes from people, tags, or comments on other objects in the event network. A content pipeline can modify an event network as new objects are added or removed from the event network, as existing objects are modified, or as relationships between objects are added, removed, or differently weighted. For example, event networks can evolve as users, curators, and other entities modify and interact with objects in the event network. Interactions can include, but are not limited to, tagging, commenting, adding material, rearranging, voting on changes, editing, or polling.

Event views can be event cards displayed on the threads of the threadboard. The user can select event cards to dig deeper into an event and to view events that are related to the selected event. If the user selects a related event, a new thread can be created that has a subject of the new event. The user can choose to add the new thread to the user's threadboard. The event card can include various portions of articles or other media relating to the event, and can further include links to the sources of the media.

Advantages of the disclosed technology include (1) efficient creation and organization of events; (2) intelligent and dynamic display and arrangement of events arranged on threads of a threadboard personalized for each user; (3) adaptive views of event details; (4) seamless creation of new threads based on a single content selection; (5) an ability to view events involving a displayable cast of characters, including a timeline of such events; (6) an ability to view commentary of and add commentary to entire events and the items that comprise the event; and (7) an ability to view displays of multiple events in the form of event cards based on a subject of a thread, where the threads (and therefore the event cards) are easily modified and can be positioned differently for each user, among other advantages.

### Event Views

Event views created by an event service can be organized and displayed in various ways. For example, event views can be displayed as event cards, event detail views, and event network views. Event cards are minimalist views that are displayed on a threadboard. Event detail views are comprehensive views about single events and include links to related events. Event network views illustrate the relation between events and objects in each event network.

Event views are constructed and displayed based on factors including, but not limited to, the identity of the user the view is constructed for (i.e., who the user is); the UI context that the view is being constructed for (type of view), the amount of “real estate” available on the device that the view is being constructed for; the display technology of the device or application the view is being constructed for; the event network and associated objects that will comprise the view; and the bandwidth available between the event service and the user device. An event can include one or more artifacts depicting information from the articles in the event. In some implementations, artifacts can include one or more of: headlines, summaries, quotes, images, audio clips, video clips, tags, topics, representations of identified entities, comments, or etc.

### Event Cards

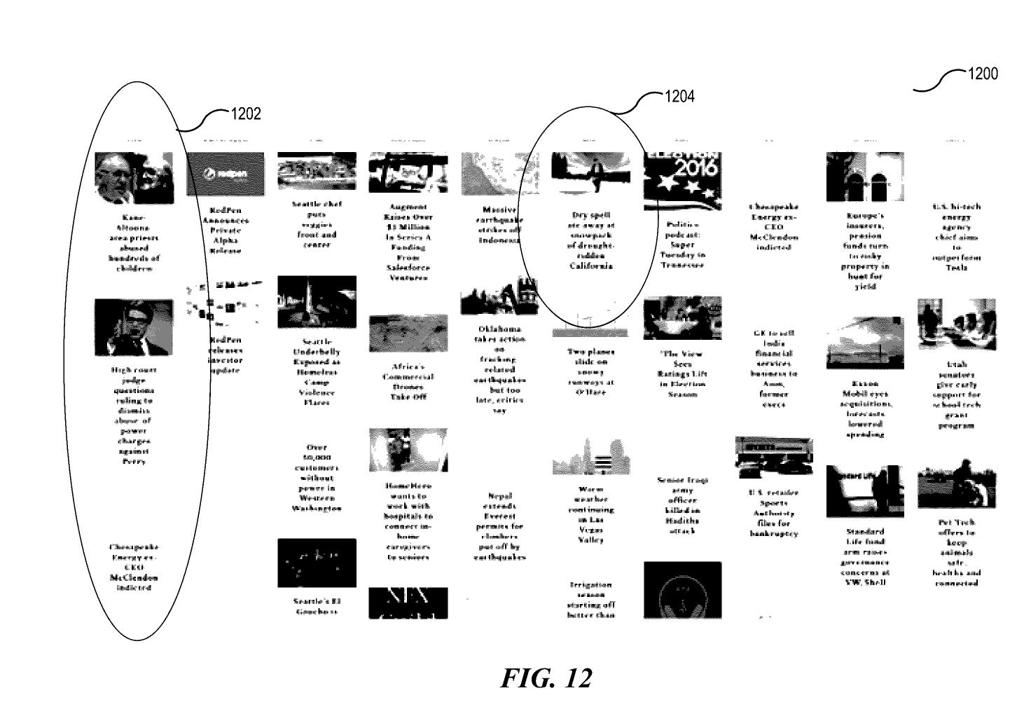

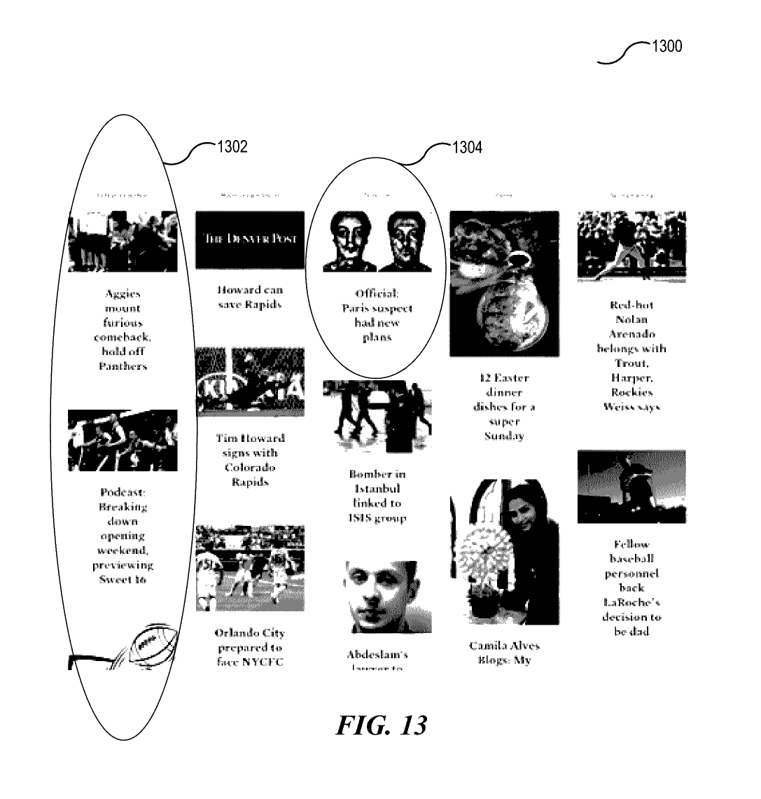

Event cards are composed of images, headlines, and/or “teaser” or “event hook” information that is intended to pique a user's interest in clicking on it. Event cards are of uniform width, but variable length, and are displayed in threads on a threadboard 1200, 1300 (described below). An example of a threadboard is shown in FIG. 12. Each event card (e.g., element 1204, 1304) represents an event, which is composed of a set of content items (e.g., articles, videos, comments) that have been published and clustered by the event service into a single event, such as an earthquake near Indonesia. Event cards are minimalist views of events, intended to provide summary information about events. The event cards can be organized in threads (e.g., element 1202, 1302) on a threadboard or search result page according to entity, topic, or emotion, as shown in FIG. 13.

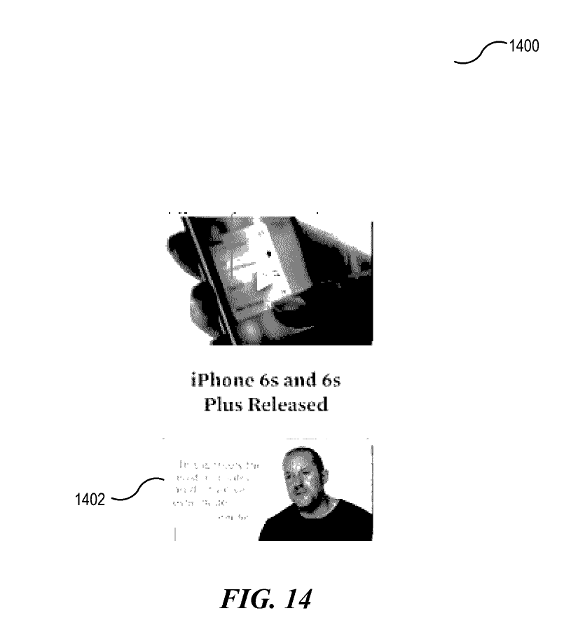

The information displayed on each event card can be customized for different users, devices, and screen sizes, but can include an image gallery that the user can navigate (or in the case of video, preview), an indication of the time and last update for the event, a headline, a summary, and an event hook. An event hook is a small amount of information intended to increase the likelihood that the user will open the event detail view to explore further. The event hook may be the same for all users, or may be constructed with the individual user in mind. In the example event card for the release of the iPhone model 500 shown in FIG. 14, the hook 1402 is a statement from Jony Ives. An example of constructing an event hook particularized for an individual is “Your Facebook friend Frank has commented on this event.” When event views are selected, the user is presented with an event detail view (described below). In some embodiments, each event card can include a displayable cast of characters and events that the characters are involved in. The event cards can allow users to view events based on a timeline.

### Constructing Event Cards

Event cards can be constructed as the client sends a request for a specific number of cards for each thread. The event network service can receive a structure of data in the form of a template selected based on a type of the event cards, allowing different types of event cards to display differently. For instance, a card for an NFL football game can include a score box, or other football-specific information. See Appendix A for a sample of the data structure for a list of event cards.

Event cards are received from the event service in the form of a structure of data in the form of a template. Below is an example of an event card data structure and template:
{“id”:“56d725101e9bde5216f92ca8”,“type”:“““title”:“Pet Tech offers to keep animals safe, healthy and connected”,“date”:“2016□03□02T00:00:00.000Z”,“summary”:[{“type”:“hero_image”,“url”:“https://re dpen□stage.s3.amazonaws.com/articles/56d711fe1e9bde5216f92ab7/ass ets/c4b35be927d3d5d32d03d87f2132dce0”,“naturalWidth”:960,“nat uralHeight”:641},{“type”:“published_date”,“date”:“2016□03□02T23:00:00.000Z”},{“type”:“title”,“text”:“Pet Tech offers to keep animals safe, healthy and connected”,“source”:“56d711fe1e9bde5216f92ab7”}]}

### Event Detail Views

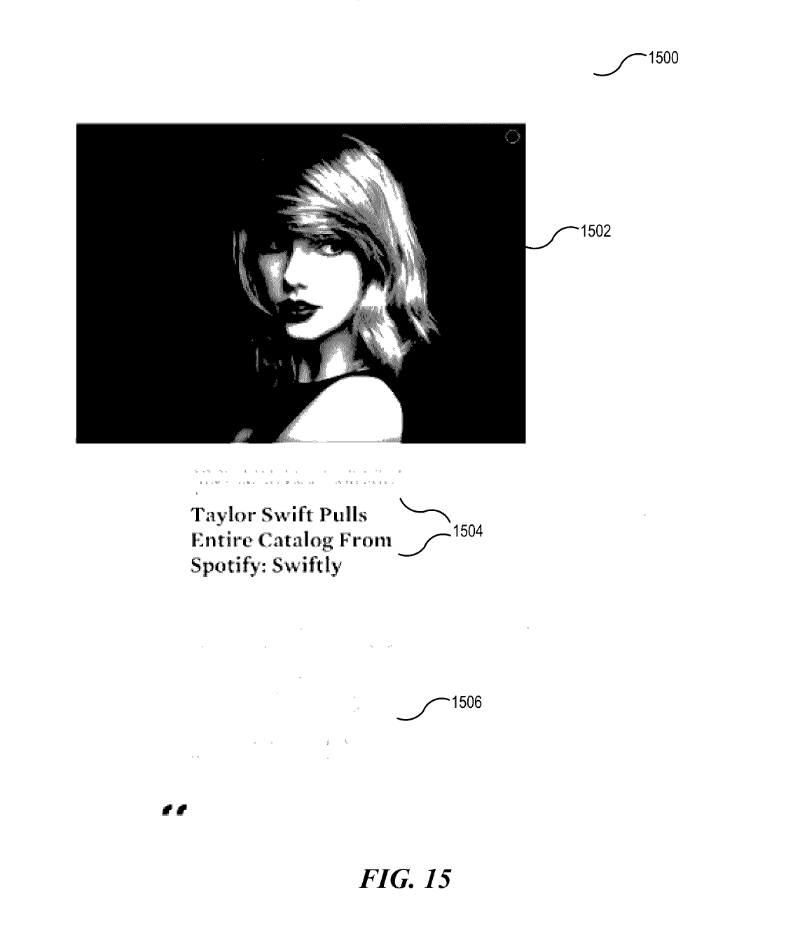

Event detail views are more complete views of events, intended to provide detailed information about events, plus the ability to explore each event much further. Event details may be shown when a user selects a specific event card. An example of a detail view 1500 shown in FIG. 15 illustrates some of the possible objects from an event network that can be included in an event detail view, including an image, video or media gallery 1502, one or more event titles/kickers 1504, event summary 1506, a date of publication of the event view, comments or tags on a portion of or entirety of the event summary, and source article information such as a source article title, source article leading paragraph, publisher, author, and link to the source article. Typically more than one source article is used to create the event detail view.

An event detail view provides a way to view and navigate a selected set of objects from an event network, with a focus on a single event and the ability to navigate to related events. The views are constructed by the event service in response to requests from clients, and templates are used to guide their display. Templates can be assigned based on the topic or type of event. For instance, an event for an NFL football game can be constructed using a template specific to NFL football games that contains elements such as a scorebox, infographics specific to football, and data from official NFL sources.

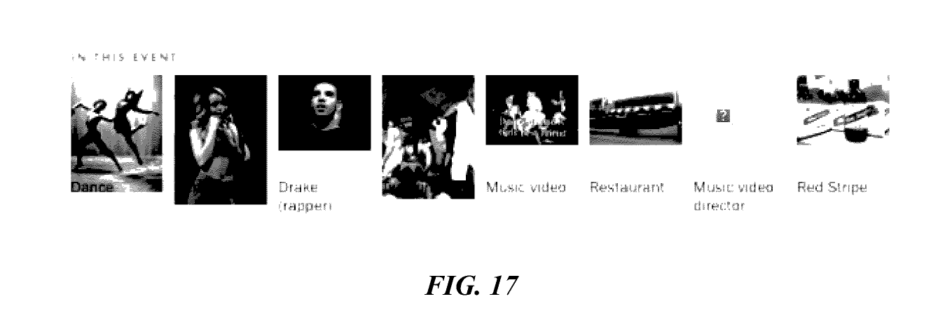

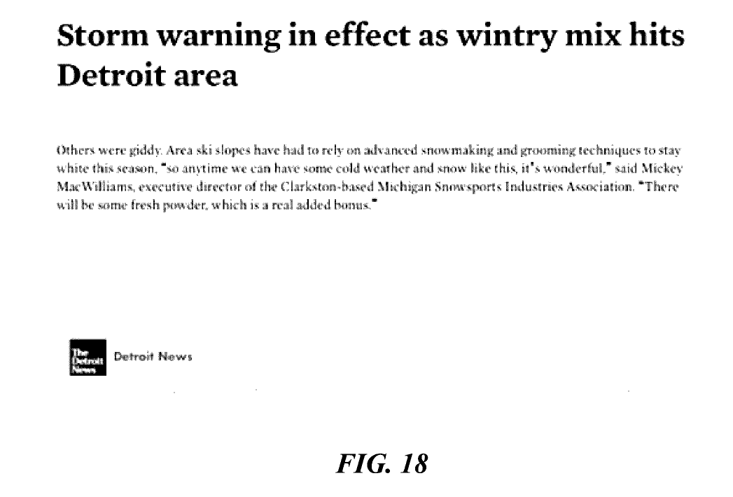

Event detail views can include further information relating to an event, such as a cast of characters associated with an event, as shown in FIG. 17, or a quote associated with a particular source, as shown in FIG. 18.

The priority at which objects are chosen to be displayed in the event detail view is controlled by a combination of the event template and the ranking of objects in the event network.

### Event Network Views

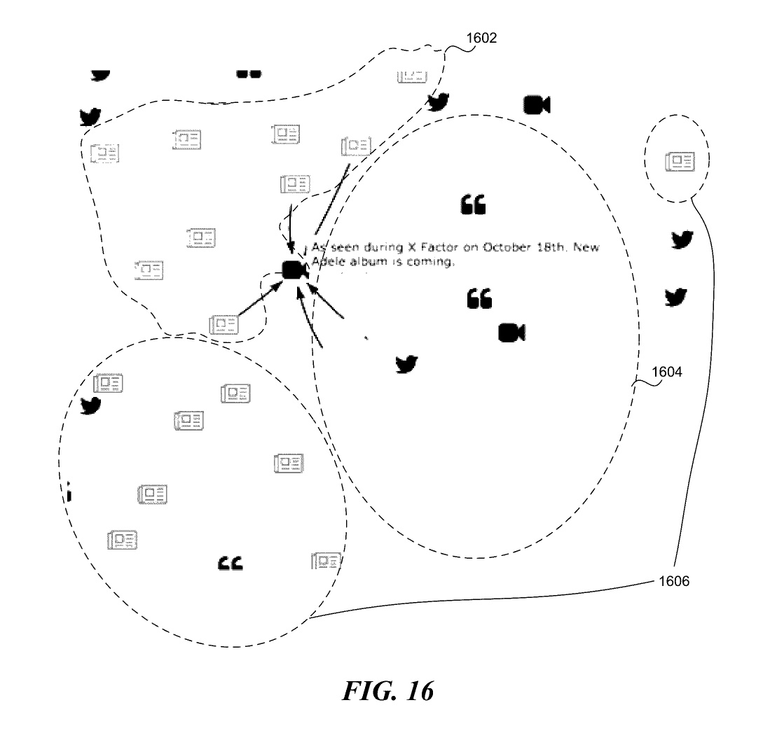

The Event Network View is based on the Event Network, which can be a graph such as the one shown in FIG. 16. The graph in FIG. 16 contains objects including published articles, videos, images, quotes from Named Entities, social network postings, and web pages. Items that the event service contributes to one event can be indicated as related (e.g., color coded). In FIG. 16, the items that are encapsulated in dotted line 1604 are considered by the event service to contribute to one event, and those items encapsulated by dotted lines 1602 and 1606 contribute to two other related events that are in the same graph. The event network view is built by displaying each of the objects as an icon identifying its type, and the links between it and any other object in the graph. The event network view shown in FIG. 16 is one non-limiting visualization of an event network view.

### Threadboard

Event views created by the event service can be organized into threads, which can be displayed on a threadboard. The threadboard is a customizable display of threads that include a series of event views related in some manner, such as by topic, entity, or emotion. An example of a threadboard is shown in FIG. 12.

The threadboard can display icons in the header area to represent a “home” button, search, user profile, and informational video links. The threadboard can be scaled to fit various screen sizes and formats, using Responsive Web technology for browsers, and native technology for device applications. The threadboard can scale from a small mobile screen displaying only one thread at a time, to a large console screen displaying many threads at a time. The size of each event card and the text and images in each event view are adaptive as well.

The event service can provide each user with categories of threads including global, recommended, emotion-based, and personal. Global threads can be threads that the event network system deems to be important or of interest to all users. For example, a global thread can include top world news. These threads can be present for all users and are visible to the user regardless of whether the user is logged in. Recommended threads can be threads that are recommended to a user based on the best information (“signals”) available about the user. In some implementations, the events in the thread can be sorted left-to-right by the likelihood that the event would be of interest at that moment in time to the user. In some implementations, the recommended threads can be present and visible for the user regardless of whether the user is logged in. Recommended threads are discussed in more detail below. Emotion-based threads can include events organized by the emotional aspects of their events (e.g., threads of sad or heartwarming events). In some implementations, the recommended threads can be present and visible for users regardless of whether the user is logged in. Personal threads can include events that the user has chosen to have present in his/her personal section of the threadboard. In some implementations, these threads are available only to users who are logged in.

### Constructing the Threadboard

When constructing the threadboard, the client makes a request to the event service for a list of threads to display (minus the event cards in the thread). The threads can be displayed linearly, meaning that each thread can be displayed in a straight line. Each thread is defined by a structure including the name (for display purposes), a type based on the way the thread is constructed (loosely relating to the categories of threads defined earlier), and a composition object. The composition object varies based on the type of thread-specified event and informs the services how to query events for itself such that the event cards are within a threshold relationship distance of the subject of the thread. The information needed to query events is created by the service for each thread topic. For example, an emotion thread needs information to determine which emotion to detect as well as a threshold of how strong the emotion must be present. In a further example, a topic thread needs a list of topics with which to use to query for events. See Appendix A for an example of the structure of the composition objects. Once the threadboard outline is constructed and downloaded, the client can then make requests for the threads to fill out the event cards at the client's or the event network services' own pace.

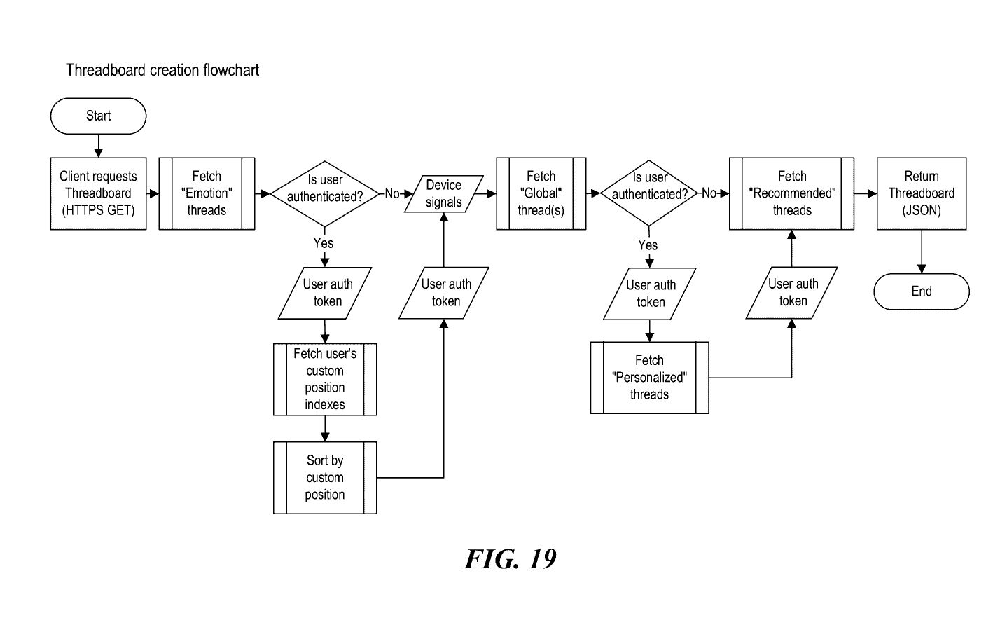

An example of a flow of constructing a threadboard is shown in FIG. 19. Once a client sends a request, the system fetches emotion threads. If the user is authenticated, then the system retrieves the user's custom position indexes indicating a custom position of the threads. Position of the threads on the threadboard means, from left to right, which thread is placed in order starting from the left. The system can sort the custom positions. Regardless of whether the user is authenticated, the system fetches global threads and again checks whether the user is authenticated. When the user is authenticated, the system fetches personal threads. Next, regardless of whether the user is authenticated, the system fetches recommended threads. Then, the threadboard is displayed.

### Threadboard Basic Navigation

Each thread of event cards can be independently scrolled vertically, and the entire threadboard can be scrolled horizontally. Vertical and horizontal scrolling can be done using available input devices such as a computer mouse, trackpad, arrow keys, or by touch on a touchscreen. The threadboard can extend left, right, and down without set limits, so that it can seem infinite in size in three directions. The threadboard can be zoomed in or out, so that fewer or more threads and cards are visible on the display at once. On smaller screen devices, only one thread may be fully visible at a time by default. Scrolling left/right can be accomplished using touch, arrow keys, or by mouse with a horizontally arranged scrollbar at the bottom of the board. Scrolling vertically can be accomplished by dragging a thread vertically, using touch, a trackpad, or a mouse (by holding down a mouse button). If the user scrolls vertically and approaches the end of the list of event cards for any given thread, the client requests an additional set of event cards from the services and extends the thread, until or unless the service has no more cards available for that thread. If the user scrolls horizontally and approaches the end of the list of threads that the client has available to display, the client requests additional threads from the service.

Selecting an event card opens the event that it represents over the top of the threadboard, obscuring some or all of the threadboard from view. Selecting the search icon opens a search dialogue, and selecting the user icon opens a user profile dialogue. If the user is not signed in, the user can sign in or sign up using a sign-in/sign-up button that is displayed.

### Threadboard Customization

In some implementations, each logged-in user can customize his/her own threadboard. In some implementations, this customization can be accomplished by: (A) moving one of the threads in one category section (e.g., the recommended category section) to another category section (e.g., by selecting the “ . . . ” at the top of the thread and choosing to move it to the personal category section); (B) accepting a thread that has been shared with the user by another user and allowing it to be added to the threadboard; (C) performing a search and choosing to add one of the resulting threads to the threadboard; (D) selecting one of the icons within an event in the “In This Event” section, displaying a thread, and then adding it to the threadboard; (E) rearranging the threads in the personal section of the threadboard, left to right (e.g., by selecting “move” from the thread menu and then dragging and dropping threads to the desired arrangement); (F) merging threads together, so that events cards that were displayed on either of the threads are now displayed in a single thread; (G) renaming threads by editing the title; (H) changing the color scheme and/or background texture of the threadboard; (I) zooming in or out so that more or fewer event cards and threads are visible at one time; (J) or any combination thereof.

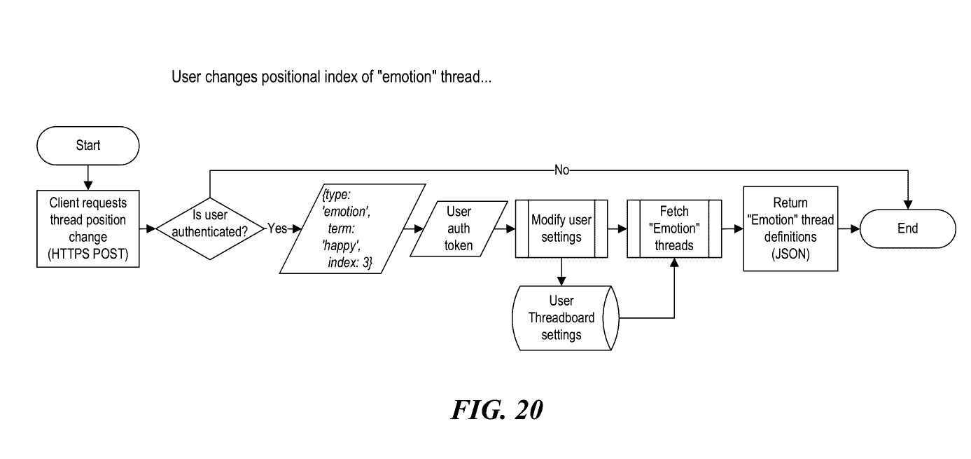

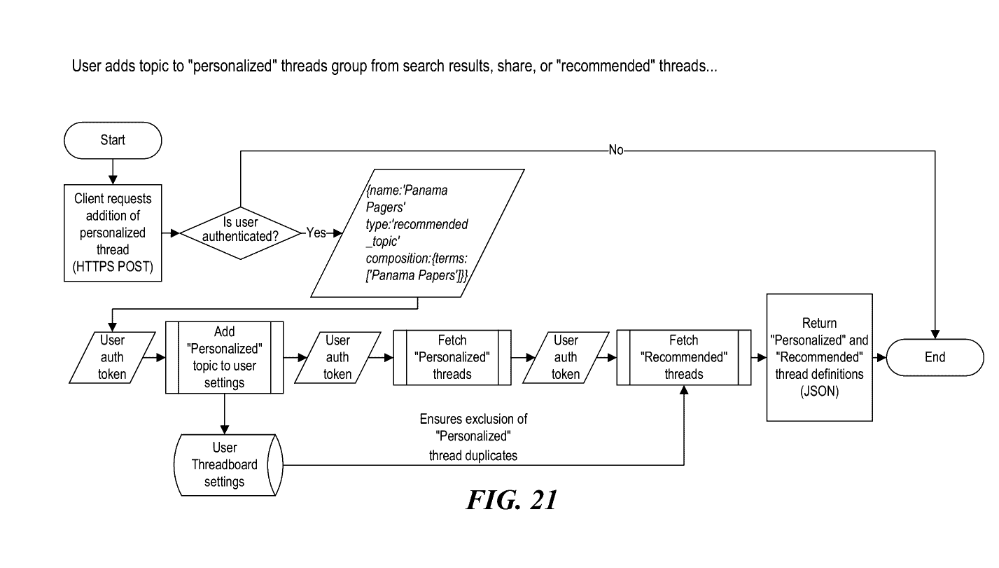

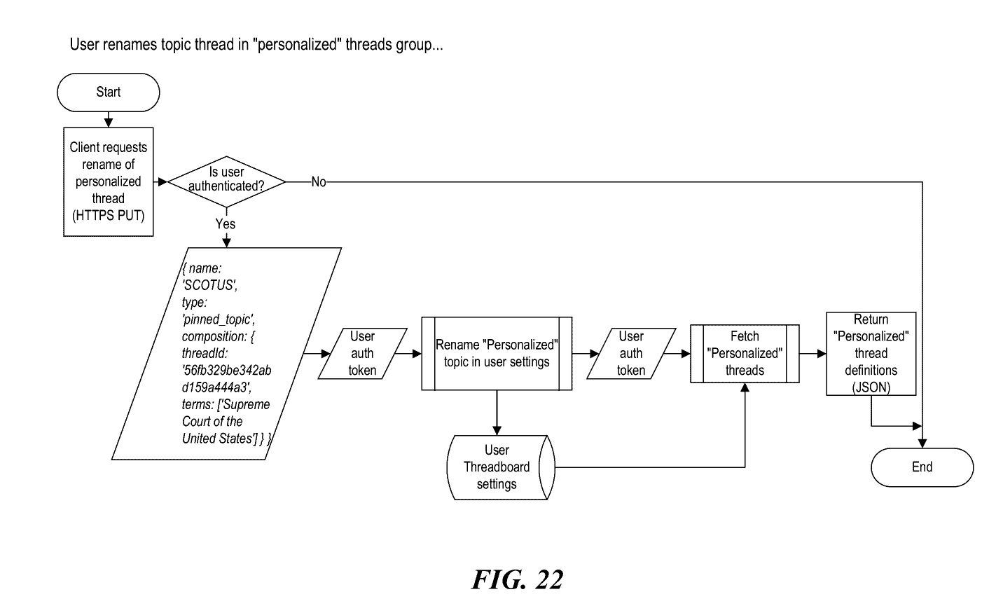

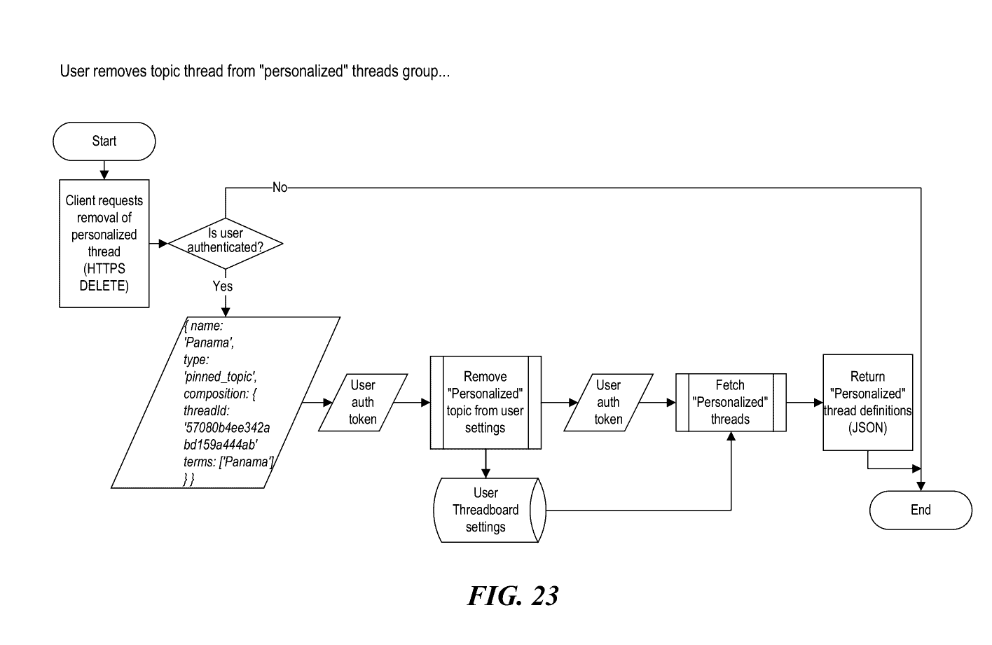

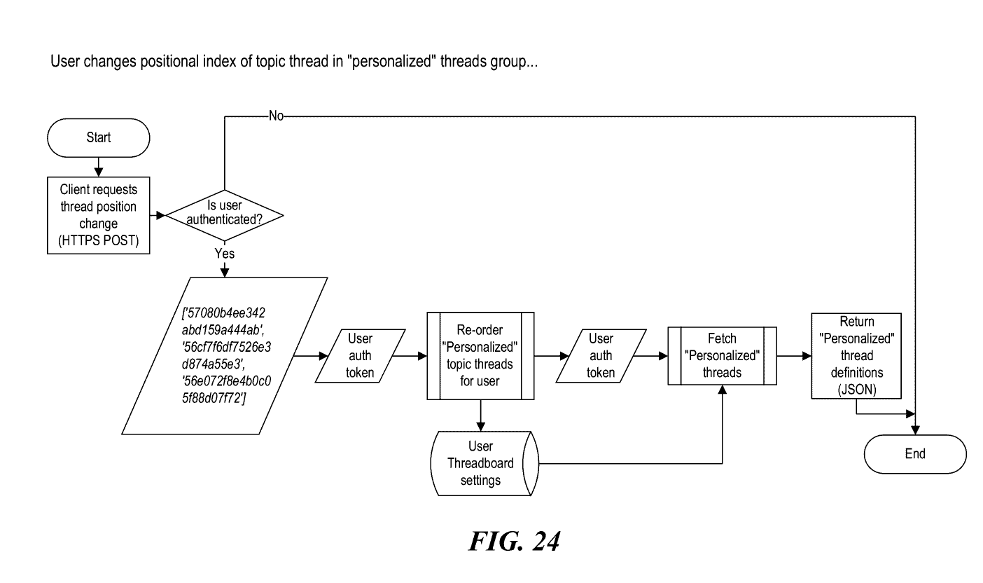

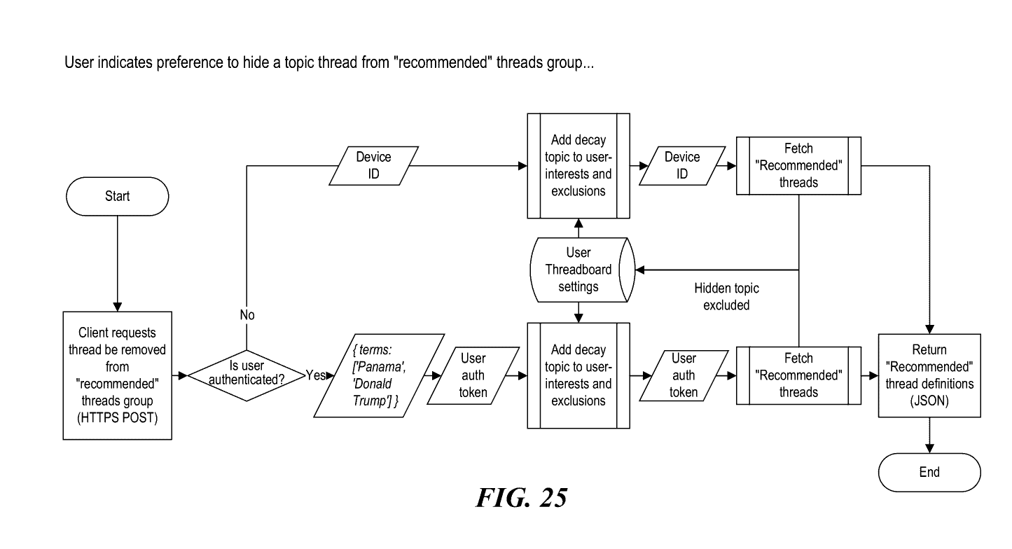

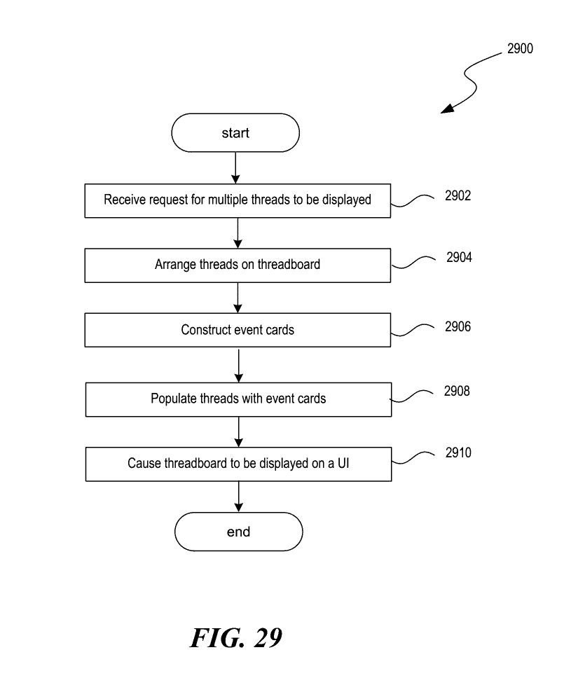

FIGS. 19-25 are flowcharts with examples of user interactions with the threadboard, and are self-explanatory to one of ordinary skill in the relevant art based on the detailed description provided herein. FIG. 29 is a flowchart illustrating operations performed by the system when a user requests a change of a positional index of an emotion thread (i.e., change a position of an emotion thread on the threadboard). FIG. 21 is a flowchart illustrating operations performed by the system when a user adds a topic to the personalized threads category from the search results, shared threads, or recommended threads. FIG. 22 is a flowchart illustrating operations performed by the system when the user renames a topic thread in the personalized threads group. FIG. 23 is a flowchart illustrating operations performed by the system when the user removes a topic thread from the personalized threads group. FIG. 24 is a flowchart illustrating operations performed by the system when the user changes a positional index of a topic thread in the personalized thread group. FIG. 25 is a flowchart illustrating operations performed by the system when the user indicates a preference to hide a topic thread from the recommended thread group.

### Search

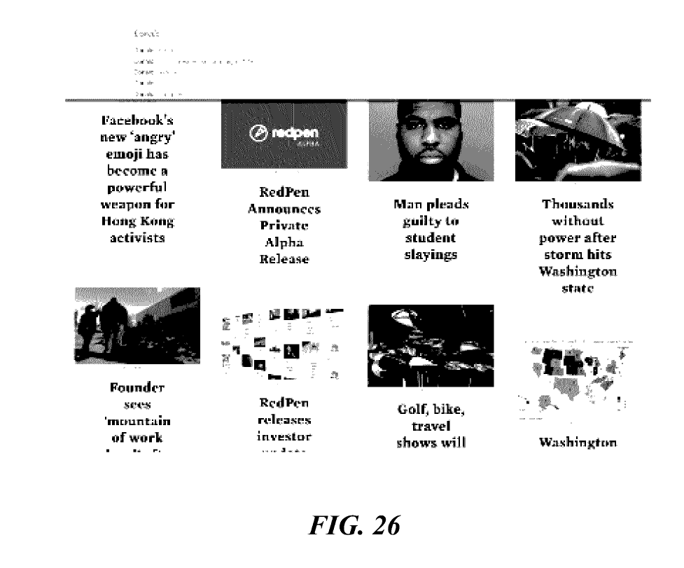

Searching on the event service can provide a beneficial user experience. As a user begins to type, the event service can generate and display auto-complete prompts for elements corresponding to known events, entities, or topics, as shown in FIG. 26. These prompts can be ordered by the freshness or an activity level assigned to the corresponding element. Freshness can be calculated for a selected element based on a combination of one or more signals, including, but not limited to, (A) a quantity score for sources of the selected element, where the quantity score can be detected by the event service on an ongoing basis (B) interactions with the selected element by other users of the event service (interactions can include viewing, sharing, tagging, commenting, etc.), or (C) activity related to the element on other social networks such as Twitter™, Facebook™′ Instagram™, etc. Thus, “auto-completed” search topic items can be presented in descending order of anticipated search intention relevance. In other words, if the system can determine that many people are currently seeking information on a topic (i.e., it is “hot”), that topic will appear very near the top of the search results),

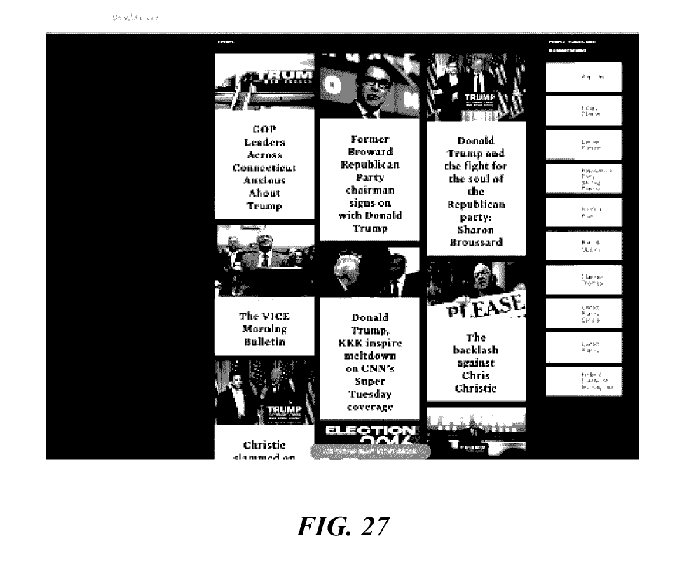

In the example shown in FIGS. 26-27, typing “Donald” resulted in an element for the entity “Donald Trump” but also an element for Donald Trump's presidential campaign, which is a more specific topic. This ability to choose very specific topics can narrow the set of returned information and can reduce clutter.

In the example shown in FIG. 27, selecting “Donald Trump” can cause the event service to search for and return a set of event cards for events in which “Donald Trump” has been identified as a Named Entity. Additionally, the event service can return a set of other entities and topics that were referenced in those events, providing the user with the ability to “go down the rabbit hole” (i.e., iteratively select a related event card of interest to the user and be presented with additional related event cards and explore those further).

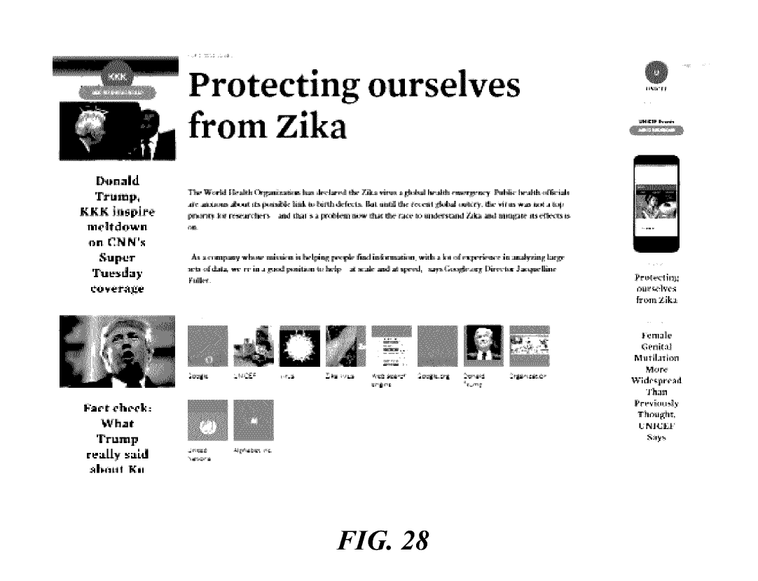

In the example shown in FIGS. 26-28, selecting any of the related topics can cause the system to present a thread specific to that topic, as shown. The thread can be presented with an option to add the thread to the user's threadboard. In the example shown in FIG. 28, the topic “Ku Klux Klan” was selected, and the system built a thread for that topic and presented it to the user. The thread can be selected to be added to the user's threadboard.

The event service can present a single thread view of the threadboard, which can be chosen by the user by selecting one of the entities or topics in an event card, where “UNICEF” was presented as a topic in the event card, and the selection resulted in a “UNICEF” thread, which could be added to the user's threadboard, as shown in FIG. 28.

### Tagging and Commenting on an Event View

Users can tag or comment on objects within an event view. Objects that can be tagged or commented on include the entire event view, images or sections of images, videos or sections of videos, headlines, summaries, sentences, quotes, names or entities, other tags, and other comments. Tags can allow the user to express a sentiment and/or an emotion about an event or object of an event quickly, with little effort from the user to categorize. Comments can be typed in and analyzed as the user is typing them. Tags and comments are stored and associated with the tagged content and an identifier of the person who provided the tag or comment.

FIG. 29 is a flowchart 2900 showing an example of constructing a threadboard. Receiving operation 2902 receives a request for multiple threads to be displayed linearly on the threadboard at an event network service. Each thread can have a subject and an set of event cards representing events that are within a threshold relationship distance of the subject of the thread. Arranging operation 2904 arranges the threads on the threadboard according to a category of the thread and a probability of user interest in the subject of the event cards. Threads with a higher probability of user interest can be arranged further to the left on the threadboard where the threads of lower interest are further to the right, causing the user to scroll horizontally to see the lower interest threads. In some implementations, only certain types of threads are arranged based on the category of the thread and the probabilyt of user interest (e.g., recommended and emotion threads), whereas other types of threads are arranged manually (e.g., personal threads). Constructing operation 2906 constructs event cards based at least in part on a type of the event. Populating operation 2908 populates each thread with event cards. Displaying operation 2910 causes the threadboard to be displayed on a user interface.

Advantages and features of the described technology include automated journalism, online news services, social media, and collaborative journalism. Further advantages and features include events on a threadboard where the events can include an event title created using automated journalism techniques or from a source article; an event summary created using automated journalism techniques from material in the event corpus; infographics, using pictures and graphs, to convey data such as statistics and sentiment about events; a media gallery which may include images, videos and sound clips; excerpts from sources in the event corpus, user-supplied text and media, and information about source reputations; the cast of characters and the events that they have been involved in, with the ability to explore data and timelines about each iteratively.

The technology described herein further supports inline expansion of larger text items in the events including source articles; iteratively updates all elements of the event as new content is discovered, contributed or added; generates, maintains and published major and minor versions of events; uses aspects including topic, entity, person, place, publication, and time to present events as cards on the threadboard, which can act as a “live feed” in a user experience, or which can be explored on a timeline, and organized by topic or entity; supports the ability to search for events and have results displayed on a threadboard organized according to factors including but not limited to people, entity, place, topic and search terms.

### Conclusion

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as “high” or “unimportant,” when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

### Conclusion

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

In various implementations, the technology can include:

Implementation 1. A system for displaying a virtual threadboard, the system comprising:
a display device operable to display a graphical user interface;
a display input/output device in communication with the display device;
a microprocessor in communication with the display input/output device and operable to execute instructions stored in memory;
a memory having microprocessor executable instructions, wherein the microprocessor executable instructions cause the microprocessor to communicate display data to the display input/output device to cause a graphical user interface to be displayed on the display device,
   wherein the graphical user interface comprises a first component to display multiple threads arranged linearly on the threadboard, each of the multiple threads having a different subject;
   wherein each of the multiple threads comprises at least two event cards representing an event;
   wherein each of the event cards was generated by an event network service that identified and retrieved a content item related to the event, and provided artifacts representing portions of the retrieved content item into the event card; and
   wherein, when the event card is selected, the graphical user interface displays an event detail view to provide additional artifacts relating to the event, the event detail view obscuring at least a portion of the displayed multiple threads.

Implementation 2. The system of implementation 1, wherein the multiple threads are arranged from left to right on the threadboard based on a probability of user interest in the event views included in the thread, wherein the threads with a higher probability are arranged further to the left.

Implementation 3. The system of implementation 1, wherein each event card includes an image, an indication of when the event view was last updated, a headline of the event, a summary of the event, an event hook of the event to entice the user to select the event, or any combination thereof.

Implementation 4. The system of implementation 1, wherein the multiple threads and the event cards are uniform and static in width, and wherein the multiple threads and the event cards vary dynamically in length, wherein the length of each of the multiple threads is based on the number of event cards in the thread.

Implementation 5. The system of implementation 1, wherein the subject is one of a topic, entity, or emotion, and wherein the multiple threads are arranged by categories, wherein the categories include at least one of global threads presented to each user, recommended threads that are specifically recommended to a user, emotion-based threads that are recommended or identified by the user and that display events evoking an emotion, and personal threads identified by the user.

Implementation 6. The system of implementation 1, wherein the event detail view includes at least one of identifiers of providers of the content items; links to related events; or tags commenting on one of the artifacts, the event, one of the content items, or the subject.

Implementation 7. A computer-implemented method for constructing a threadboard, the method comprising:
receiving, at an event network service, a request for multiple threads to be displayed linearly on the threadboard,
   wherein each thread has a subject and at least one event card representing an event that is within a threshold relationship distance of the subject of the thread;
arranging the multiple threads on the threadboard according to a category of the thread and a probability of user interest in the subject of the at least one event card;
constructing, by a processor, the at least one event card based at least in part on a type of the event;
populating each thread with the at least one event card; and causing the threadboard to be displayed on a user interface.

Implementation 8. The computer-implemented method of implementation 7, wherein each of the at least one event cards includes a set of content items relating to the event, wherein the set of content items has been published to the Internet and clustered together to provide a summary of the event, the summary including artifacts from one or more of the set of content items.

Implementation 9. The computer-implemented method of implementation 7 further comprising customizing content displayed on each of the event cards based on an identity of the user and a size of the user interface, wherein the event cards are uniform in width and varying in length.

Implementation 10. The computer-implemented method of implementation 7 further comprising:
defining each of the threads by a structure, a name, a type, and a composition object; and
querying, by the event network service, one or more databases for the events based on the composition object, wherein the composition object defines how to query events to meet the threshold relationship distance of the subject.

Implementation 11. The computer-implemented method of implementation 7, wherein the subject comprises a topic, entity, or emotion, wherein the category comprises at least one of global, recommended, personal, or emotion-based, and wherein the computer-implemented method further comprises requiring authentication credentials prior to arranging the multiple threads based on a recommended category or a personal category.

Implementation 12. The computer-implemented method of implementation 7 further comprising:
receiving, at the event network service, from the client device, a selection of one of the event cards; and
in response to receiving the selection, generating an event detail view of the event, the event detail view structured by a type of the event and providing a summary of the event, the summary including artifacts representing portions of multiple content items related to the event.

Implementation 13. The computer-implemented method of implementation 12 further comprising:
displaying the event detail view on the user interface, the event detail view obscuring at least a portion of the threadboard.

Implementation 14. The computer-implemented method of implementation 7 further comprising:
in response to receiving a horizontal scroll request extending past the multiple threads displayed on the user interface, generating additional threads and displaying the additional threads.

Implementation 15. The computer-implemented method of implementation 7 further comprising:
in response to receiving a request for additional event cards in a selected thread, constructing additional event cards in the selected thread;
adding the additional event cards to the selected thread; and
displaying the additional event cards on the user interface.

Implementation 16. A system comprising:
a processor;
a memory having instructions stored thereon that, when executed by the processor, cause a graphical user interface to be displayed on a display device, wherein the user interface:
   displays a threadboard having linear threads that comprise event cards representing events,
      wherein the events relate to a subject of the thread, and
      wherein the threads are arranged on the threadboard according to a category of the thread;
   in response to receiving a selection of one of the event cards, displays an event detail view of the event represented on the selected event card,
      wherein the event detail view includes a summary of the event and selectable related subjects,
      wherein the summary includes artifacts generated from a cluster of content items, and
      wherein the event detail view overlays onto at least a portion of the displayed threads;
   displays an additional thread, including event cards representing the related subject, in response to receiving a selection of one of the related subjects; and
   when an indication to add the additional thread to the threadboard is received, positions the additional thread on the threadboard according to the category of the additional thread.

Implementation 17. The system of implementation 16, wherein the user interface further:

receives an input comprising a search query or an initial portion of the search query;

displays at least one potential thread having a subject related to the search query or the initial portion of the search query, the at least one potential thread comprising the event cards relating to the search query or the initial portion of the search query; and
upon receiving a selection to add the at least one potential thread to the threadboard, displays the threadboard updated with the at least one potential thread.

Implementation 18. The system of implementation 16, wherein the user interface further:

receives login credentials; and

upon receiving a verification of the login credentials, displays an updated threadboard, including threads categorized as personal.

Implementation 19. The system of implementation 16, wherein the subject includes one or more of entity, topic, or emotion, wherein the categories include one or more of recommended, personal, global, and emotion-based.

Implementation 20. The system of implementation 16, wherein the user interface further:
repositions a thread on the threadboard in response to receiving a selection, drag, and drop of the thread to a right side or a left side of a position of the thread on the threadboard.

Implementation 21. The system of implementation 16, wherein the user interface further:
merges a first thread into a second thread in response to receiving a selection, drag, and drop of the first thread into the second thread, wherein merging includes adding the event cards in the first thread to the second thread.

Implementation 22. The system of implementation 16, wherein the user interface further:
receives a tag of an artifact, wherein the event network system updates event views in other threadboards with the tag.

Implementation 23. A non-transitory computer-readable storage medium containing a set of instructions that, when executed by one or more processors, cause a machine to:
display multiple threads arranged linearly on the threadboard, wherein each thread displays event cards,
wherein each thread has a subject and at least one event card;
create, within each event card, events involving a displayable cast of characters,
wherein the events and the displayable cast of characters are within a threshold relationship distance of the subject of the thread;
position the threads from left to right on the threadboard according to a category of the thread and a probability of user interest in the event cards in the thread; and
upon receiving a selection of one of the threads, display an event detail view of the event represented on the selected event card,
   wherein the event detail view includes a summary of the event, sources of artifacts that comprise the summary, and selectable related subjects, and
   wherein the event detail view provides a timeline of the event.

APPENDIX A
Sample of the Structure of the Composition Objects

| | |
|---|---|
| 1. | [[{name: “Happy”, type: “emotion”, composition: {emotion: “happy”, threshold: 0.5}}, ], ] |

| | |
|---|---|
| 1. | 0:[{name: “Happy”, type: “emotion”, composition: {emotion: “happy”, threshold: 0.5}}, ] |

| | |
|---|---|
| 1. | 0:{name: “Happy”, type: “emotion”, composition: {emotion: “happy”, threshold: |

0.5}}

| | |
|---|---|
| 1. | composition:{emotion: “happy”, threshold: 0.5} |
| 2. | name:“Happy” |
| 3. | type:“emotion” |

| 2. | 1:{name: “Sad”, type: “emotion”, composition: {emotion: “sad”, threshold: 0.5}} |
|---|---|
| 3. | 2:{name: “Disgusting”, type: “emotion”, composition: {emotion: “disgusting”, |
| | threshold: 0.5}} |
| 4. | 3:{name: “Heartwarming”, type: “emotion”, composition: {emotion: “heartwarming”, |
| | threshold: 0.5}} |
| 5. | 4:{name: “Angry”, type: “emotion”, composition: {emotion: “angry”, threshold: |
| | 0.5}} |
| 6. | 5:{name: “Surprising”, type: “emotion”, composition: {emotion: “surprising”, |

threshold: 0.5}}

| | |
|---|---|
| 2. | 1:[{name: “Global”, type: “global”, composition: { }}, {name: “RedPen Development”, |

type: “curated”, }]

| | |
|---|---|
| 1. | 0:{name: “Global”, type: “global”, composition: { }} |

| | |
|---|---|
| 1. | composition:{ } |
| 2. | name:“Global” |
| 3. | type:“global” |

| | |
|---|---|
| 2. | 1:{name: “RedPen Development”, type: “curated”, } |

| | |
|---|---|
| 3. | 2:[{name: “Seattle”, type: “pinned_topic”, }, {name: “Startup company”, type: |

“pinned_topic”, }, ]

| | |
|---|---|
| 1. | 0:{name: “Seattle”, type: “pinned_topic”, } |

| | |
|---|---|
| 1. | composition:{threadId: “56d1c0e9d2123f091939fd44”, terms: [“Seattle”]} |
| 2. | name:“Seattle” |
| 3. | type:“pinned_topic” |

| 2. | 1:{name: “Startup company”, type: “pinned_topic”, } |
|---|---|
| 3. | 2:{name: “Wine”, type: “pinned_topic”, } |
| 4. | 3:{name: “Stock market”, type: “pinned_topic”, } |
| 5. | 4:{name: “Macklemore & Ryan Lewis”, type: “pinned_topic”, } |
| 6. | 5:{name: “Zika virus”, type: “recommended_topic”, composition: {terms: [“Zika |
| | virus”]}} |
| 7. | 6:{name: “Politics”, type: “recommended_topic”, composition: {terms: |
| | [“Politics”]}} |
| 8. | 7:{name: “Business”, type: “recommended_topic”, composition: {terms: |
| | [“Business”]}} |
| 9. | 8:{name: “Investment”, type: “recommended_topic”, composition: {terms: |
| | [“Investment”]}} |
| 10. | 9:{name: “Technology”, type: “recommended_topic”, composition: {terms: |
| | [“Technology”]}} |
| 11. | 10:{name: “College basketball”, type: “recommended_topic”, composition: {terms: |
| | [“College basketball”]}} |
| 12. | 11:{name: “Major League Soccer”, type: “recommended_topic”, composition: {terms: |
| | [“Major League Soccer”]}} |
| 13. | 12:{name: “Wine”, type: “recommended_topic”, composition: {terms: [“Wine”]}} |
| 14. | 13:{name: “Entertainment”, type: “recommended_topic”, composition: {terms: |
| | [“Entertainment”]}} |
| 15. | 14:{name: “South by Southwest”, type: “recommended_topic”, composition: {terms: |
| | [“South by Southwest”]}} |
| 16. | 15:{name: “Nancy Reagan”, type: “recommended_topic”, composition: {terms: |
| | [“Nancy Reagan”]}} |
| 17. | 16:{name: “Fine art”, type: “recommended_topic”, composition: {terms: [“Fine |

art”]}}

Sample Of The Data Structure For A List Of Event Cards
{header: {name: “Startup company”, type: “pinned_topic”, }, }

| | |
|---|---|
| 1. | events:[{id: “56d725101e9bde5216f92ca8”, type: “”, }, ] |

| | |
|---|---|
| 1. | 0:{id: “56d725101e9bde5216f92ca8”, type: “”, } |

| | |
|---|---|
| 1. | date:“2016-03-02T00:00:00.000Z” |
| 2. | id:“56d725101e9bde5216f92ca8” |
| 3. | summary:[{type: “hero_image”, }, {type: “published_date”, date: “2016- |

03-02T23:00:00.000Z”}, ]

| | |
|---|---|
| 1. | 0:{type: “hero_image”, } |

| | |
|---|---|
| 1. | naturalHeight:641 |
| 2. | naturalWidth:960 |
| 3. | type:“hero_image” |
| 4. | url:“https://redpen- |

stage.s3.amazonaws.com/articles/56d711fc1c9bde5216f92ab7/asse
ts/c4b35bc927d3d5d32d03d37f2132dce0”

| | |
|---|---|
| 2. | 1:{type: “published_date”, date: “2016-03-02T23:00:00.000Z”} |

| | |
|---|---|
| 1. | date:“2016-03-02T23:00:00.000Z” |
| 2. | type:“published_date” |

| | |
|---|---|
| 3. | 2:{type: “title”, text: “Pet Tech offers to keep animals safe, |

healthy and connected”, }

| 1. | source:“56d711fe1e9bde5216f92ab7” |
|---|---|
| 2. | text:“Pet Tech offers to keep animals safe, healthy and |
| | connected” |
| 3. | type:“title” |

| | |
|---|---|
| 4. | title:“Pet Tech offers to keep animals safe, healthy and connected” |
| 5. | type;“” |

{“header”:{“name”:“Startup
company”,“type”:“pinned_topic”,“composition”:{“threadId”:“56d1c111d2123f091939fd46”,“te
rms”:[“Startup company”]}},“events”:[{“id”:“56d725101e9bde5216f92ca8”,“type”:“”,“title”:“Pet
Tech offers to keep animals safe, healthy and connected”,“date”:“2016-03-
02T00:00:00.000Z”,“summary”:[{“type”:“hero_image”,“url”:“https://redpen-
stage.s3.amazonaws.com/articles/56d711fe1e9bde5216f92ab7/assets/c4b35be927d3d5d32d0
3d87f2132dce0”,“naturalWidth”:960,“naturalHeight”:641},{“type”:“published_date”,“date”:“20
16-03-02T23:00:00.000Z”},{“type”:“title”,“text”:“Pet Tech offers to keep animals safe, healthy
and
connected”,“source”:“56d711fe1e9bde5216f92ab7”}]},{“id”:“56d76ec61e9bde5216f934a7”,“ty
pe”:“”,“title”:“Dot & Bo to help startups with office design”,“date”:“2016-03-
02T19:00:00.000Z”,“summary”:[{“type”:“hero_image”,“url”:“https://redpen-
stage.s3.amazonaws.com/articles/56d763791e9bde5216f9310c/assets/b9d075b7cc6cadb5baf7
7f2f27b855a4”,“naturalWidth”:764,“naturalHeight”:400},{“type”:“published_date”,“date”:“201
6-03-02T19:00:00.000Z”,}{“type”:“title”,“text”:“Dot & Bo to help startups with office
design”,“source”:“56d763791e9bde5216f9310c”}]},{“id”:“56d79f901e9bde5216f93f95”,“type”:
“”,“title”:“Pitch competitions give tech companies practice”,“date”:“2016-03-
02T18:34:00.000Z”,“summary”:[{“type”:“hero_image”,“url”:“https://redpen-
stage.s3.amazonaws.com/articles/56d777741e9bde5216f93821/assets/a44f3854c9bfb4bd209
25375e80b616e”,“naturalWidth”:750,“naturalHeight”:422},{“type”:“published_date”,“date”:“2
016-03-02T18:34:00.000Z”},{“type”:“title”,“text”:“Pitch competitions give tech companies
practice”,“source”:“56d777741e9bde5216f93821”}]},{“id”:“56d76ebb1e9bde5216f9349e”,“typ
e”:“”,“title”:“GoTenna raises $7.5M and launches with REI to keep cell phones connected
without cell towers”,“date”:“2016-03-
02T17:20:00.000Z”,“summary”:[{“type”:“hero_image”,“url”:“https://redpen-
stage.s3.amazonaws.com/articles/56d763bb1e9bde5216f93131/assets/dc4c2a61dc44ebc8802
a312238ff4e89”,“naturalWidth”:738,“naturalHeight”:554},{“type”:“published_date”,“date”:“20
16-03-02T18:00:00.000Z”},{“type”:“title”,“text”:“GoTenna raises $7.5M and launches with REI
to keep cell phones connected without cell
towers”,“source”:“56d763bb1e9bde5216f93131”}]},{“id”:“56d702e21e9bde5216f9279a”,“type
”:“”,“title”:“SugarCRM acquires Contastic for natural language-based predictive sales
tools”,“date”:“2016-03-
02T12:00:00.000Z”,“summary”:[{“type”:“hero_image”,“url”:“https://redpen-
stage.s3.amazonaws.com/articles/56d6f1ce1e9bde5216f923dc/assets/f3f6371aa86c9a1d9de9
37eb36a0357f”,“naturalWidth”:738,“naturalHeight”:387},{“type”:“published_date”,“date”:“201
6-03-02T17:00:00.000Z”},{“type”:“title”,“text”:“SugarCRM acquires Contastic for natural
language-based predictive sales
tools”,“source”:“56d6f1ce1e9bde5216f923dc”}]},{“id”:“56d6fa7f1e9bde5216f925a6”,“type”:“”,
“title”:“Augmented reality starts to challenge its virtual cousin”,“date”:“2016-03-
02T00:00:00.000Z”,“summary”:[{“type”:“hero_image”,“url”:“https://redpen-
stage.s3.amazonaws.com/articles/56d763951e9bde5216f9311e/assets/bb42e28ef5e8d837774
62c867f3e857e”,“naturalWidth”:960,“naturalHeight”:640},{“type”:“published_date”,“date”:“20
16-03-02T15:19:00.000Z”},{“type”:“title”,“text”:“Augmented reality starts to challenge its
virtual
cousin”,“source”:“56d6f6561e9bde5216f924c8”}]},{“id”:“56d76e9d1e9bde5216f9348b”,“type”:
“”,“title”:“State lawmakers could place limits on noncompete clauses”,“date”:“2016-03-
02T12:55:00.000Z”,“summary”:[{“type”:“hero_image”,“url”:“https://redpen-
stage.s3.amazonaws.com/articles/56d762931e9bde5216f930e6/assets/fda29d54f2d1041f7f45
b0c9d869339e”,“naturalWidth”:850,“naturalHeight”:478},{“type”:“published_date”,“date”:“20
16-03-02T12:55:00.000Z”},{“type”:“title”,“text”:“State lawmakers could place limits on
noncompete
clauses”,“source”:“56d762931e9bde5216f930e6”}]},{“id”:“56d703701e9bde5216f927b8”,“type
”:“”,“title”:“Africa's Commercial Drones Take Off”,“date”:“2016-03-
02T11:31:00.000Z”,“summary”:[{“type”:“hero_image”,“url”:“https://redpen-
stage.s3.amazonaws.com/articles/56d6f1e61e9bde5216f923e3/assets/28569b687a488bce422
efaa61ff96bd3”,“naturalWidth”:738,“naturalHeight”:416},{“type”:“published_date”,“date”:“20
16-03-02T11:31:00.000Z”},{“type”:“title”,“text”:“Africa's Commercial Drones Take
Off”,“source”:“56d6f1e61e9bde5216f923e3”}]},{“id”:“56d6a6701e9bde5216f91efb”,“type”:“”,“
title”:“HomeHero wants to work with hospitals to connect in-home caregivers to
seniors”,“date”:“2016-03-
02T04:00:00.000Z”,“summary”:[{“type”:“hero_image”,“url”:“https://redpen-
stage.s3.amazonaws.com/articles/56d685821e9bde5216f91648/assets/ca2e2d8580abfaa8235
83b3e57ff2706”,“naturalWidth”:738,“naturalHeight”:415},{“type”:“published_date”,“date”:“20
16-03-02T04:01:00.000Z”},{“type”:“title”,“text”:“HomeHero wants to work with hospitals to
connect in-home caregivers to
seniors”,“source”:“56d685821e9bde5216f91648”}]},{“id”,“56d6a6061e9bde5216f91edb”,“type
”:“”,“title”:“Accelerator NFX Guild unveiled its second startup batch today: Here's who just
graduated”,“date”:“2016-03-
02T00:19:00.000Z”,“summary”:[{“type”:“hero_image”,“url”:“https://redpen-
stage.s3.amazonaws.com/articles/56d6856d1e9bde5216f9163f/assets/04c6f87073f0e725c20fc
4a9c6145802”,“naturalWidth”:712,“naturalHeight”:400},{“type”:“published_date”,“date”:“201
6-03-02T01:00:00.000Z”},{“type”:“title”,“text”:“Accelerator NFX Guild unveiled its second
startup batch today: Here's who just
graduated”,“source”:“56d6856d1e9bde5216f9163f”}]},{“id”:“56d631d21e9bde5216f90988”,“ty
pe”:“”,“title”:“Pantry Fuel delivers: Spokane startup offers maximum-nutrition, minimum-
maintenance meals”,“date”:“2016-03-
01T00:00:00.000Z”,“summary”:[{“type”:“hero_image”,“url”:“https://redpen-
stage.s3.amazonaws.com/articles/56d62a191e9bde5216f904c9/assets/e5b41c5aa4fe857a196c
56b04ebc8021”,“naturalWidth”:253,“naturalHeight”:450},{“type”:“published_date”,“date”:“20
16-03-01T21:23:00.000Z”},{“type”:“title”,“text”:“Pantry Fuel delivers: Spokane startup offers
maximum-nutrition, minimum-maintenance
meals”,“source”:“56d62a191e9bde5216f904c9”}]},{“id”:“56d61a921e9bde5216f8f93b”,“type”:“
”,“title”:“Meet the foxes behind LA's latest startup gem”,“date”,“2016-03-
01T21:00:00.000Z”,“summary”:[{“type”:“hero_image”,“url”:“https://redpen-
stage.s3.amazonaws.com/articles/56d617bb1e9bde5216f8f79b/assets/29ece66d006896a778ff
7d976792bc57”,“naturalWidth”:738,“naturalHeight”:382},{“type”,“published_date”,“date”:“20
16-03-01T21:00:00.000Z”},{“type”:“title”,“text”:“Meet the foxes behind LA's latest startup
gem”,“source”:“56d617bb1e9bde5216f8f79b”}]},{“id”:“56d599861e9bde5216f8ef2a”,“type”:“”,,
“title”:“Uber's real estate footprint unmatched among S.F. Bay Area startups”,“date”:“2016-03-
01T12:07:00.000Z”,“summary”:[{“type”:“hero_image”,“url”:“https://redpen-
stage.s3.amazonaws.com/articles/56d595f11e9bde5216f8eef3/assets/6db173309ab0a979e61
5accf99f4e004”,“naturalWidth”:644,“naturalHeight”:436},{“type”:“published_date”,“date”:“20
16-03-01T18:28:00.000Z”},{“type”:“title”,“text”:“Uber's real estate footprint unmatched among
S.F. Bay Area
startups”,“source”:“56d595f11e9bde5216f8eef3”}]},{“id”:“56d689ee1e9bde5216f917a4”,“type
”:“”,“title”:“Cybersecurity Startups Describe New Fundraising Hurdles”,“date”:“2016-03-
01T07:53:00.000Z”,“summary”:[{“type”:“hero_image”,“url”:“https://redpen-
stage.s3.amazonaws.com/articles/56d62c631e9bde5216f906c3/assets/9672eecb8f98d8e11b0
666963e51dae2”,“naturalWidth”:0,“naturalHeight”:0}:{“type”,“published_date”,“date”:“2016-
03-01T18:11:00.000Z”},{“type”:“title”,“text”:“Cybersecurity Startups Describe New Fundraising
Hurdles”,“source”:“56d62c631e9bde5216f906c3”}]},{“id”:“56d5d8b81e9bde5216f8f1e0”,“type
”:“”,“title”:“Former wealth management executive joins Digital Asset Board”,“date”:“2016-03-
01T17:10:00.000Z”,“summary”:[{“type”:“hero_image”,“url”:“https://redpen-
stage.s3.amazonaws.com/articles/56d5d4d71e9bde5216f8f1bf/assets/9d2ff5c2b47f70fe006ad
c5da4101cec”,“naturalWidth”:644,“naturalHeight”:475},{“type”:“published_date”,“date”:“2016
-03-01T17:10:00.000Z”},{“type”:“title”,“text”:“Former wealth management executive joins
Digital Asset
Board”,“source”:“56d5d4d71e9bde5216f8f1bf”}]},{“id”:“56d618cd1e9bde5216f8f7fd”,“type”:“”
,“title”:“What's Causing Google's Average Ad Price to Decline?”,“date”:“2016-03-
01T00:00:00.000Z”,“summary”:[{“type”:“hero_image”,“url”:“https://redpen-
stage.s3.amazonaws.com/articles/56d617b61e9bde5216f8f798/assets/a1c9a2524bcede2c8f77
16bd41bfbc06”,“naturalWidth”:738,“naturalHeight”:390},{“type”:“published_date”,“date”:“201
6-03-01T17:00:00.000Z”},{“type”:“title”,“text”:“What's Causing Google's Average Ad Price to
Decline?”,“source”:“56d6137b1e9bde5216f8f52b”}]},{“id”:“56d61a861e9bde5216f8f930”,“type
”:“”,“title”:“Sign Up To Volunteer At Disrupt NY”,“date”:“2016-03-
01T15:01:00.000Z”,“summary”:[{“type”:“hero_image”,“url”:“https://redpen-
stage.s3.amazonaws.com/articles/56d617f71e9bde5216f8f7c1/assets/f46134c7ee0bdcb2c3e3
0cdddf222c53”,“naturalWidth”:738,“naturalHeight”:541},{“type”:“published_date”,“date”:“201
6-03-01T15:01:00.000Z”},{“type”:“title”,“text”:“Sign Up To Volunteer At Disrupt
NY”,“source”:“56d617f71e9bde5216f8f7c1”}]},{“id”:“56d643e71e9bde5216f90f5a”,“type”:“”,“ti
tle”:“Startup Grind links Treasure Valley techies to Silicon Valley”,“date”:“2016-03-
01T11:39:00.000Z”,“summary”:[{“type”:“hero_image”,“url”:“https://redpen-
stage.s3.amazonaws.com/articles/56d624da1e9bde5216f9006b/assets/1d662bb75b6ffd0b997
441bbf1dc9001”,“naturalWidth”:1140,“naturalHeight”:712},{“type”:“published_date”,“date”:“2
016-03-01T11:42:00.000Z”},{“type”:“title”,“text”:“Startup Grind links Treasure Valley techies to
Silicon
Valley”,“source”:“56d624da1e9bde5216f9006b”}]},{“id”:“56d4de391e9bde5216f8e61b”,“type”:
“”,“title”:“Google's self-driving car hits municipal bus”,“date”:“2016-02-
29T00:00:00.000Z”,“summary”:[{“type”:“hero_image”,“url”:“https://redpen-
stage.s3.amazonaws.com/articles/56d4dd5f1e9bde5216f8e562/assets/a97486e6b1aea7a7d86
b3eb6585b3fc7”,“naturalWidth”:1020,“naturalHeight”:633},{“type”:“published_date”,“date”:“2
016-02-29T23:31:00.000Z”},{“type”:“title”,“text”:“Google's self-driving car hits municipal
bus”,“source”:“56d4dd6f1e9bde5216f8e562”}]},{“id”:“56d628eb1e9bde5216f903ad”,“type”:“”,
“title”:“Alpha Loft chooses six Accelerate companies”,“date”:“2016-02-
29T20:26:00.000Z”,“summary”:[{“type”:“published_date”,“date”:“2016-02-
29T20:26:00.000Z”},{“type”:“title”,“text”:“Alpha Loft chooses six Accelerate
companies”,“source”:“56d61c891e9bde5216f8fabb”}]}],“totals”:{“total”:1000000}}

I/we claim:

1. A method for constructing an event network, the method comprising:
discovering a content item from a data source;
analyzing the content item by identifying named entities based on:
tags provided by a user, the content item being matched to identifiers that are mapped to named entities, or any combination thereof;
decomposing component parts of the content item by atomizing the content item into portions and identifying a portion tag for at least one of the portions;
receiving an indication of a similarity graph specifying:
one or more other content items as nodes, and
edges between the nodes as identified connections between the other content items;
inserting a representation of the content item into the similarity graph by (i) creating a new node in the similarity graph that corresponds to the content item and (ii) adding, to the similarity graph, one or more new edges between the new node and one or more of the nodes in the similarity graph,
wherein the one or more new edges are created based on identified connections between the content item and the other content items;
identifying, based on the similarity graph, a cluster of content items including the content item and the other content items; and
generating artifacts for the cluster of content items and organizing the artifacts into an event view,
wherein the artifacts comprise representations of portions of multiple of the content items in the cluster of content items.

2. The method of claim 1 further comprising:
receiving one or more additional tags related to the content item; and
in response to receiving the one or more additional tags, updating the similarity graph or updating the cluster of content items, and, based on the updated similarity graph or the updated cluster of content items, generating a new event view with one or more new artifacts.

3. The method of claim 2, wherein receiving the one or more additional tags comprises:
identifying one or more entities that the user may be commenting on or identifying one or more sentiments about an entity that a user may be trying to express;
prompting the user for verification of the identified one or more entities or for verification of the one or more sentiments;
receiving input responding to the prompting that verifies the identified one or more entities or the one or more sentiments; and
in response to the input responding to the prompting, storing one or more associations of the one or more additional tags to the verified one or more entities or the verified one or more sentiments.

4. The method of claim 1 further comprising updating the event view to include an indication of aggregated user sentiment relating to the cluster of content items by:
identifying, in a sentiment lexicon, one or more words or n-grams from user comments related to the cluster of content items, wherein the sentiment lexicon correlates the identified one or more words or n-grams with a sentiment attribute comprising positive, negative, or neutral;
computing an overall sentiment polarity for one or more of the user comments as a function of sentiment polarities of words contained therein; and
including an indication of the overall sentiment polarity in the event view.

5. The method of claim 1 wherein analyzing the content item further comprises:
identifying a language the content item was written in; and
assigning to the content item a unique identifier.

6. The method of claim 1 wherein analyzing the content item further comprises identifying author sentiment based on sentiment indicators in the content item.

7. The method of claim 1 wherein analyzing the content item further comprises attributing one or more quotes in the content item to a corresponding identified named entity by:
detecting a quote by identifying a pair of matching quotation marks; and
allocating the detected quote to the corresponding identified named entity by:
identifying an expression verb within a first defined area around the detected quote; and
locating the corresponding identified named entity in a second defined area around the identified expression verb.

8. The method of claim 1 wherein processing the one or more images associated with the content item further includes:
producing a globally unique identifier for the one or more images by hashing the one or more images;
removing duplicates from the one or more images;
ranking the one or more images based on an analysis of captions and metadata associated with the one or more images; and
adjusting the one or more images to have consistent size and resolution characteristics.

9. The method of claim 1 wherein decomposing component parts of the content item is further performed by identifying one or more publishers of the content item and metadata associated with the identified one or more publishers.

10. The method of claim 1 wherein the portion tag for each of the portions comprise: headline, section, paragraph, publisher, author, titles, quote, image, image caption, video, video caption, charts or other infographic, comment, or any combination thereof.

11. The method of claim 1 wherein identifying the cluster of content items is performed by assigning one or more similarity scores between the content item and at least one of the one or more other content items and determining that the similarity score, for each content item in the cluster of content items, is within a similarity score threshold.

12. The method of claim 11 wherein each similarity score between the content item and one of the other content items are computed based on:
presence, count, or frequency of matching quotes between the content item and one of the other content items;
presence, count, or frequency of matching tags between the content item and one of the other content items;
presence, count, or frequency of matching titles or headlines between the content item and one of the other content items;
a minimum number of edges in the similarity graph between the node representing the content item and the node representing one of the other content items; or any combination thereof.

13. The method of claim 1 wherein the artifacts are selected from sources that include web crawling or social network APIs.

14. The method of claim 1 wherein the artifacts include: headlines, summaries, quotes, images, audio clips, video clips, tags, topics, representations of identified entities, comments, or any combination thereof.

15. The method of claim 1 wherein analyzing the content item further comprises processing one or more images associated with the content item to select a primary image, from the one or more images, to be used as a featured image for the content item.

16. A computer-readable storage medium, excluding only transitory signals, and storing instructions that, when executed by a computing system, cause the computing system to perform operations for identifying elements for a recommend thread, the operations comprising:
identifying one or more signals with corresponding user values,
wherein each of the one or more signals is a category of user information, and
wherein each corresponding user value identifies a characteristic, in the category of user information, for a selected user;
receiving identifications of one or more potential elements, the one or more potential elements comprising: events, topics, entities, or any combination thereof;
computing an interest score for each particular potential element of the one or more potential elements by:
computing, based on the one or more signals, signal effects specifying how each of the corresponding user values is expected to effect a level of interest, in the particular potential element, by the selected user; and
computing the interest score for the particular potential element based on a combination of the computed signal effects;
identifying the elements for the recommend thread by selecting, from the potential elements, elements that have interest scores that are above a threshold; and
sorting the identified elements that have interest scores that are above the threshold based on the corresponding interest scores.

17. The computer-readable storage medium of claim 16 wherein the categories of user information comprise one or more of: status, intention, interest, circumstance, context, or any combination thereof.

18. The computer-readable storage medium of claim 16 wherein the categories of user information comprise one or more of: location or movement data, social network activity, device specifics, age, personal description, social network friends, search topics, or any combination thereof.

19. The computer-readable storage medium of claim 16 wherein computing the interest score comprises creating a model based on a user profile associated with the selected user and using the model to compute the interest score.

20. The computer-readable storage medium of claim 16 wherein computing the signal effects uses (A) weighting factors or (B) results of interpreting user intent from the one or more signal.

21. The computer-readable storage medium of claim 16 wherein computing the interest score is further based on matching characteristics of an event against relevant features in the user's profile.

22. The computer-readable storage medium of claim 16 wherein at least one of the categories of user information comprise location or movement for times-of-day or days-of-the-week.

23. A system for performing a search against an event network, the system comprising:
a memory; and
one or more processors;
wherein the memory stores instructions that, when executed by the one or more processors, causes the one or more processors to perform operations comprising:
receiving an initial portion of a search query comprising less than all of the search query;
identifying two or more potential auto-complete results matching the initial portion of the search query,
wherein at least one of the two or more potential auto-complete results corresponds to an event, entity, or topic on a similarity graph;
computing a freshness or activity level for each particular result of the two or more potential auto-complete results,
wherein each freshness or activity level is based on a combination of signals comprising: (A) a quantity score computed for a source of the particular result, (B) recorded interactions with the particular result by other users, (C) activity related to the particular result on other social networks, or (D) any combination thereof;
sorting the two or more potential auto-complete results based on the freshness or activity levels; and
providing the sorted two or more potential auto-complete results.

24. The system of claim 23,
wherein computing the freshness or activity level is based on a combination of signals comprising at least recorded interactions with the particular result by other users, and
wherein the recorded interactions include one or more of: viewing, sharing, tagging, commenting, or any combination thereof.

25. The system of claim 23, wherein the operations further comprise:
receiving a selection of a result of the two or more potential auto-complete results;
performing a search of the event network based on the selected result,
wherein search results are presented by identified keyword in the search results, topics to the search results, and time characteristics associated with the search results.
